(19) United States
(12) Patent Application Publication
(10) Pub. No.: US 2020/0111491 A1
(43) Pub. Date: Apr. 9, 2020

(54) Speech enabled user interaction

(71) Applicant: Alkira Software Holdings Pty Ltd., Queensland (AU)

(72) Inventor: Raymond James GUY, Doonan (AU)

(21) Appl. No.: 16/593,515

(22) Filed: Oct. 4, 2019

(30) Foreign Application Priority Data
Oct. 8, 2018 (AU) 2018903787
Oct. 8, 2018 (AU) 2018903788
Oct. 8, 2018 (AU) 2018903789
Oct. 8, 2018 (AU) 2018903790
Oct. 8, 2018 (AU) 2018903791

(51) Int. Cl. G10L 15/22; G10L 15/02; G10L 15/26; G10L 15/30; G06F 3/16; G06F 17/27; G06F 17/28

(52) U.S. Cl. CPC G10L 15/22; G10L 15/02; G10L 15/265; G10L 2015/223; G06F 3/167; G06F 17/2785; G06F 17/28; G10L 15/30

(57) ABSTRACT

A system for enabling user interaction with content, the system including an interaction processing system, including one or more electronic processing devices configured to obtain content code representing content that can be displayed, obtain interface code indicative of an interface structure, construct a speech interface by populating the interface structure using content obtained from the content code, generate interface data indicative of the speech interface and, provide the interface data to an interface system to cause the interface system to generate audible speech output indicative of a speech interface.

### BACKGROUND OF THE INVENTION

In one expe [symbol] , the present invention re [symbol] tes to [symbol] ethod and system for f [symbol] ci [symbol] it [symbol] ting speech en [symbol] b [symbol] ed user inter [symbol] ction. In one ex p e [symbol] , the present invention re [symbol] tes to ethod nd syste for f [symbol] ci [symbol] it [symbol] ting speech en b ed user inter [symbol] ction. In one expe [symbol] , the present invention re [symbol] tes to [symbol] ethod [symbol] nd syste [symbol] processing content, nd in one p rticu r ex p e for processing content to ow user inter [symbol] ction with the content. In one ex [symbol] p e [symbol] , the present invention re [symbol] tes to [symbol] ethod [symbol] nd syste presenting content, nd in one p [symbol] rticu [symbol] r ex [symbol] p [symbol] e for processing webp ges to fci it te user inter [symbol] ction. In one ex [symbol] p [symbol] e [symbol] , the present invention re [symbol] tes to [symbol] ethod [symbol] nd syste [symbol] presenting content, [symbol] nd in one p [symbol] rticu r ex [symbol] p [symbol] e [symbol] for odifying content to f [symbol] ci [symbol] it [symbol] te present tion.

### DESCRIPTION OF THE PRIOR ART

The reference in this specific tion to ny prior pub [symbol] ic [symbol] tion (or infor [symbol] tion derived fro it), or to [symbol] ny [symbol] tter which is known, is not, nd shou [symbol] d not be t [symbol] ken s n cknow [symbol] edg [symbol] ent or d [symbol] ission or ny for of suggestion th [symbol] t the prior pub [symbol] ic [symbol] tion (or infor tion derived fro it) or known [symbol] tter for [symbol] s p [symbol] rt of the co [symbol] on gener [symbol] know [symbol] edge in the fie d of ende your to which this specific [symbol] tion re [symbol] tes.

Speech b [symbol] sed interfces, such s Goog [symbol] e's Ho [symbol] e Assist [symbol] nt [symbol] nd A zon's A ex, re [symbol] beco [symbol] ing [symbol] ore popu [symbol] r. However, it is current [symbol] y very difficu [symbol] t to use these syste [symbol] s to inter [symbol] ct with content that is nor [symbol] y presented by co [symbol] puter syste [symbol] in visu [symbol] nner. For ex p e [symbol] , webpages represented on gr [symbol] phic user interface [symbol] nd therefore require users to be b [symbol] e to see [symbol] nd underst [symbol] nd content [symbol] nd [symbol] nv [symbol] v [symbol] i [symbol] b [symbol] e input options.

One so [symbol] ution to this prob [symbol] e [symbol] invo [symbol] ves using screen re [symbol] ders to re d out content th t is nor [symbol] y presented on the screen sequenti [symbol] y. However, this kes [symbol] it difficu [symbol] t [symbol] nd ti [symbol] e consu [symbol] ing for users to n [symbol] vig [symbol] te to n ppropri [symbol] te oc [symbol] tion on webp [symbol] ge, p rticu r if the webp [symbol] ge inc [symbol] udes signific [symbol] nt [symbol] ount of content. Addition y, such so [symbol] utions re [symbol] un [symbol] b e to represent the content of gr [symbol] phics or i [symbol] ges un [symbol] ess they h [symbol] ve been ppropri [symbol] te [symbol] y t [symbol] gged, resu [symbol] ting in [symbol] uch of the e [symbol] ning of webp [symbol] ges being [symbol] ost.

Attempts have been made to address such issues. For example, the Web Content Accessibility Guidelines (WCAG) define tags attributes that should be included in the websites to assist navigation tools, such as screen readers. However, the implementation required that these tags attributes are intrinsic to website design and must be implemented by web site authors. There are currently limited support for these from web templates and whilst these have been adopted by many governments, who can mandate their use, there has been limited adoption by business. This problem is further exacerbated by the fact that such accessibility is not of concern to most users or developers, and the associated design requirements tend to run contra to typical design aims, which are largely aesthetically focused.

WO2018/132863 describes a method for facilitating user interaction with content including, in a suitably programmed computer system, using a browser application to: obtain content code from a content server in accordance with a content address; and, construct an object model including a number of objects and each object having associated object content, and the object model being useable to allow the content to be displayed by the browser application; using an interface application to: obtain interface code from an speech server; obtain any required object content from the browser application; present a user interface to the user in accordance with the interface code and any required object content; determine at least one user input in response to presentation of the interface; and, generate a browser instruction in accordance with the user input and interface code; and, using the browser application to execute the browser instruction to thereby interact with the content.

One problem associated with speech based interfaces is that of inaccurate speech recognition. In particular, speech input is typically provided in a non-ideal environment, subject to external factors, such as noise, or other interference. Furthermore, speech based interfaces are often not tailored to individual users, and must therefore be able to handle a range of different accents, languages and dialects. As a result, speech recognition is not always accurate, and consequently is not suitable for accurate data entry, particularly when entering complex information, such as web addresses, or similar.

A further issue that arises particularly with speech based platforms is that of processing speech. In particular, processing of speech is computationally very expensive and it is not therefore feasible to perform this locally on a device and instead speech data is upload to a cloud based environment for analysis. However, this in turn results in additional problems, in that the cloud environment must be capable of handling a large number of concurrent conversations. In order to achieve this, the system is configured to terminate conversations after a period of time with no activity. This timeout process therefore provides load balancing and makes resource available to handle other conversations. However, in the context of presenting website content, this is problematic as the website content often takes longer than the timeout period to process into a usable form, leading to timeouts being triggered. When this occurs it is then necessary to restart the process from scratch, which is frustrating for users.

One problem associated with the above described technique is that interface code is largely static, meaning that the content is not always presented in the most effective manner to facilitate user interaction. Particularly in the case of speech based interfaces, this can lead to a waste in computational resources in presenting needless content.

One problem associated with the above described technique is that interface code must be defined for each webpage individually, which is a time consuming process, using significant computational resources. Furthermore, in circumstances where an interface is not defined, this makes it difficult to present the content in an appropriate manner, particularly via speech enabled user interfaces.

One problem associated with the above described technique is that websites are often tailored to be presented in a visual manner, for example including visual clues or information, which cannot easily be presented in a non-visual form. This makes it difficult to present the content in an appropriate manner, particularly via speech enabled user interfaces.

### SUMMARY OF THE PRESENT INVENTION

In one broad form, an aspect of the present invention seeks to provide a system for enabling user interaction with content, the system including an interaction processing system, including one or more electronic processing devices configured to: obtain content code representing content that can be displayed; obtain interface code indicative of an interface structure; construct a speech interface by populating the interface structure using content obtained from the content code; generate interface data indicative of the speech interface; and, provide the interface data to an interface system to cause the interface system to generate audible speech output indicative of a speech interface.

In one embodiment the system is for interpreting speech input and the interaction processing system is configured to: receive input data from the interface system in response to an audible user inputs relating to a content interaction, the input data being at least partially indicative of one or more terms identified using speech recognition techniques; perform analysis of the terms at least to determine an interpreted user input; and, perform an interaction with the content in accordance with the interpreted user input.

In one embodiment the interaction processing system is configured to cause the interface system to obtain a user response confirming if the interpreted user input is correct.

In one embodiment the interaction processing system is configured to: generate request data based on the interpreted user input; provide the request data to the interface system to cause the interface system to generate audible speech output indicative of the interpreted user input; receive input data from the interface system in response to an audible user response, the input data being at least partially indicative of the user response; and, selectively perform the interaction in accordance with the user response.

In one embodiment the interaction processing system is configured to: determine multiple possible interpreted user inputs; and, cause the interface system to obtain a user response confirming which interpreted user input is correct.

In one embodiment the interaction processing system is configured to: identify an instruction; and, analyse the terms in accordance with the instruction to determine the interpreted user input.

In one embodiment the interaction processing system is configured to identify the instruction from at least one of: the interface; and, using the terms.

In one embodiment the interaction processing system is configured to generate the interface data in accordance with the instruction.

In one embodiment the interaction processing system is configured to interpret at least some of the terms as letters spelling a word.

In one embodiment the interaction processing system is configured to cause the interface system to: generate audible speech output indicative of the spelling; and, obtain a user response confirming if the spelling is correct.

In one embodiment the terms include at least one of: an identifier indicative of a previously stored user input; natural language words; and, phonemes.

In one embodiment the interaction processing system is configured to perform the analysis at least in part by: comparing the terms to at least one of: stored data; the interface code; the content code; the content; and, the interface; and, using the results of the comparison to determine the interpreted user input.

In one embodiment the interaction processing system is configured to compare the terms using at least one of: word matching; phrase matching; fuzzy logic; and, fuzzy matching.

In one embodiment the interaction processing system is configured to: identify a number of potential interpreted user inputs; calculate a score for each potential interpreted user input; and, determine the interpreted user input by selecting one or more of the potential user inputs using the calculated scores.

In one embodiment the interaction processing system is configured to: receive an indication of a user identity from the interface system; and, perform analysis of the terms at least in part using stored data associated with the user using the user identity.

In one embodiment stored data is associated with an interaction system user account linked to an interface system user account, and wherein the interface system determines the user identity using the interface system user account.

In one embodiment the system is for facilitating speech driven user interaction with content and wherein the interaction processing system is configured to cause the user interface system to request an audible response from a user via the speech driven client device to thereby prevent session timeout whilst the interface data is generated.

In one embodiment the interaction processing system is configured to provide request data to the user interface system to cause the user interface system to request the audible response.

In one embodiment the interaction processing system is configured to: generate the request data based on the interaction request; generate the request data based on the interface code; and, retrieve predefined request data.

In one embodiment the interaction processing system is configured to generate request data indicative of the interaction request and wherein the user interface system is responsive to the request data to request user confirmation the interaction request is correct via a speech driven client device.

In one embodiment the content includes a form, and wherein interaction processing system is configured to: determine form responses required to complete the form using the interface code; and, generate request data indicative of the form responses, wherein the user interface system is responsive to the request data to: request user responses via a speech driven client device; and, generate response data indicative of user responses; receive the response data; use the response data to determine form responses; and, populate the form with the form responses.

In one embodiment the interaction processing system is configured to: determine a time to generate the interface data; and, selectively generate response data depending on the time.

In one embodiment the interaction processing system is configured to determine the time by: monitoring the time taken to retrieve content data; monitoring the time taken to populate the interface structure; predicting the time taken to populate the interface structure; and, retrieving time data indicative of a previous time to generate the interface data.

In one embodiment the interaction processing system is configured to: receive an interaction request from an interface system; obtain the content code and interface code at least partially in accordance with the interaction request.

In one embodiment the interaction processing system is configured to: obtain the content code in accordance with a content address; and, obtain interface code in accordance with the content address.

In one embodiment the interface system includes a speech processing system that is configured to: generate speech interface data; provide the speech interface data to a speech enabled client device, wherein the speech enabled client device is responsive to the speech interface data to: generate audible speech output indicative of a speech interface; detect audible speech inputs indicative of a user input; and, generate speech input data indicative of the speech inputs; receive speech input data; and, use the speech input data generate the input data.

In one embodiment the speech processing system is configured to: perform speech recognition on the speech input data to identify terms; compare the identified terms of defined phrases; and, selectively generate the input data in accordance with results of the analysis.

In one embodiment the speech processing system is configured to: receive the interface data; and, generate the speech interface data using the interface data.

In one broad form, an aspect of the present invention seeks to provide a method for enabling user interaction with content, the method including, in an interaction processing system including one or more electronic processing devices: obtaining content code representing content that can be displayed; obtaining interface code indicative of an interface structure; constructing a speech interface by populating the interface structure using content obtained from the content code; generating interface data indicative of the speech interface; and, providing the interface data to an interface system to cause the interface system to generate audible speech output indicative of a speech interface.

In one broad form, an aspect of the present invention seeks to provide a computer program product for enabling user interaction with content, the system including an interaction processing system, including one or more electronic processing devices configured to: obtain content code representing content that can be displayed; obtain interface code indicative of an interface structure; construct a speech interface by populating the interface structure using content obtained from the content code; generate interface data indicative of the speech interface; and, provide the interface data to an interface system to cause the interface system to generate audible speech output indicative of a speech interface.

In one broad form, an aspect of the present invention seeks to provide a system for interpreting speech input to enable user interaction with content, the computer executable code when executed by a suitably programmed interaction processing system, including one or more electronic processing devices, causes the interaction system to: obtain content code representing content that can be displayed; obtain interface code indicative of an interface structure; construct a speech interface by populating the interface structure using content obtained from the content code; generate interface data indicative of the speech interface; provide the interface data to an interface system to cause the interface system to generate audible speech output indicative of a speech interface; receive input data from the interface system in response to an audible user inputs relating to a content interaction, the input data being at least partially indicative of one or more terms identified using speech recognition techniques; perform analysis of the terms at least to determine an interpreted user input; and, perform an interaction with the content in accordance with the interpreted user input.

In one broad form, an aspect of the present invention seeks to provide a method for interpreting speech input to enable user interaction with content, the method including, in an interaction processing system including one or more electronic processing devices: obtaining content code representing content that can be displayed; obtaining interface code indicative of an interface structure; constructing a speech interface by populating the interface structure using content obtained from the content code; generating interface data indicative of the speech interface; providing the interface data to an interface system to cause the interface system to generate audible speech output indicative of a speech interface; receiving input data from the interface system in response to an audible user inputs relating to a content interaction, the input data being at least partially indicative of one or more terms identified using speech recognition techniques; performing analysis of the terms at least to determine an interpreted user input; and, performing an interaction with the content in accordance with the interpreted user input.

In one broad form, an aspect of the present invention seeks to provide a computer program product including computer executable code for interpreting speech input to enable user interaction with content, the computer executable code when executed by a suitably programmed interaction processing system, including one or more electronic processing devices, causes the interaction system to: obtain content code representing content that can be displayed; obtain interface code indicative of an interface structure; construct a speech interface by populating the interface structure using content obtained from the content code; generate interface data indicative of the speech interface; provide the interface data to an interface system to cause the interface system to generate audible speech output indicative of a speech interface; receive input data from the interface system in response to an audible user inputs relating to a content interaction, the input data being at least partially indicative of one or more terms identified using speech recognition techniques; perform analysis of the terms at least to determine an interpreted user input; and, perform an interaction with the content in accordance with the interpreted user input.

In one broad form, an aspect of the present invention seeks to provide a system for facilitating speech driven user interaction with content, the system including an interaction processing system, including one or more electronic processing devices that: receive an interaction request from a user interface system; obtain content code in accordance with the interaction request, the content code representing content that can be displayed; obtain interface code at least partially in accordance with the interaction request, the interface code being indicative of an interface structure; construct a speech interface by populating the interface structure using content obtained from the content code; generate interface data indicative of the speech interface; and, provide the interface data to the user interface system to allow the user interface system to present audible speech output indicative of at least the content using a speech driven client device, and wherein the interaction system causes the user interface system to request an audible response from a user via the speech driven client device to thereby prevent session timeout whilst the interface data is generated.

In one broad form, an aspect of the present invention seeks to provide a method for facilitating speech driven user interaction with content, the method including in an interaction processing system including one or more electronic processing devices: receiving an interaction request from a user interface system obtaining content code in accordance with the interaction request, the content code representing content that can be displayed; obtaining interface code at least partially in accordance with the interaction request, the interface code being indicative of an interface structure; constructing a speech interface by populating the interface structure using content obtained from the content code; generating interface data indicative of the speech interface; and, providing the interface data to the user interface system to allow the user interface system to present audible speech output indicative of at least the content using a speech driven client device, and wherein the interaction system causes the user interface system to request an audible response from a user via the speech driven client device to thereby prevent session timeout whilst the interface data is generated.

In one broad form, an aspect of the present invention seeks to provide a computer program product including computer executable code for facilitating speech driven user interaction with content, wherein the computer executable code, when executed by a suitably programmed interaction processing system including one or more electronic processing devices, causes the interaction processing system to: receive an interaction request from a user interface system; obtain content code in accordance with the interaction request, the content code representing content that can be displayed; obtain interface code at least partially in accordance with the interaction request, the interface code being indicative of an interface structure; construct a speech interface by populating the interface structure using content obtained from the content code; generate interface data indicative of the speech interface, and, provide the interface data to the user interface system to allow the user interface system to present audible speech output indicative of at least the content using a speech driven client device, and wherein the interaction system causes the user interface system to request an audible response from a user via the speech driven client device to thereby prevent session timeout whilst the interface data is generated.

In one broad form, an aspect of the present invention seeks to provide a system for processing content to allow user interaction with the content, the system including an interaction processing system, including one or more electronic processing devices that are configured to: obtain content code representing content that can be displayed; obtain interface code indicative of an interface structure; parse the content code to determine a content condition associated with at least part of the content; use the content condition to construct an interface by populating the interface structure using content obtained from the content code; generate interface data indicative of the interface; and, provide the interface data to a user interface system to allow the user interface system to present an interface including content from the content code to allow user interaction with the content.

In one embodiment the content condition is at least one of: a content presence; a content absence; a content element state; whether content is enabled or visible; and, whether content is disabled or hidden.

In one embodiment the one or more processing devices are configured to: perform a content interaction; and, determine the content condition in response to performing the content interaction.

In one embodiment the one or more processing devices are configured to: obtain updated content code as a result of the content interaction; and, parse the updated content code to determine the content condition.

In one embodiment the one or more processing devices are configured to: determine object content by constructing an object model indicative of the content from the content code; and, use the object content to at least one of: determine the content state; and, populate the interface.

In one embodiment the one or more processing devices are configured to: determine a content type of at least part of the content; and, determine the content condition at least in part using the content type.

In one embodiment the part of the content is at least one of: a section; and, an element.

In one embodiment the one or more processing devices are configured to: identify tags associated with the content from the content code using a query language; and, use the tags to determine a content type of at least part of the content.

In one embodiment the query language is XPath.

In one embodiment the one or more processing devices are configured to: use the content condition to identify an action; and, perform the action in order to generate the interface.

In one embodiment the action includes at least one of: modifying the interface structure; and, navigating the interface structure.

In one embodiment the action includes at least one of: modifying the content; processing the content; navigating the content; selecting content to exclude from the interface; and, selecting content to include in the interface.

In one embodiment the content includes a form, wherein the one or more processing devices are configured to: parse the content to determine a form field condition indicative of whether the form field is enabled; and, at least one of: if the form field is enabled or visible, the action includes present an interface including the form field; and, if the form field is disabled or hidden, the action includes present an interface omitting the form field.

In one embodiment the action includes: using the content state to obtain executable code; using the executable code to modify the content to generate modified content; and, generating interface data indicative of an interface using the modified content.

In one embodiment the action includes: using the content state to retrieve processing rules; processing the content using the processing rules; and generating the interface data by populating the interface structure with processed content.

In one embodiment the processing rules define a template for interpreting the content.

In one embodiment the action includes: generating stylization data; and, generating the interface data using the stylization data.

In one embodiment the content code includes style code, and wherein the one or more processing devices: use the style code to generate stylization data; and, generate the interface data using the stylization data.

In one embodiment the one or more processing devices are configured to: receive an interaction request from a user interface system; and, use the interaction request to at least one of: perform an interaction in accordance with the interaction request; obtain the content code; and, obtain the interface code.

In one embodiment the interface is a speech interface and wherein the user interface system presents audible speech output indicative of at least the content using a speech driven client device.

In one embodiment the user interface system includes a speech processing system that is configured to: generate speech interface data; provide the speech interface data to a speech enabled client device, wherein the speech enabled client device is responsive to the speech interface data to: generate audible speech output indicative of a speech interface; detect audible speech commands indicative of a user input; and, generate speech command data indicative of the speech commands; receive speech command data; and, use the speech command data to at least one of: identify a user; and, determine a service interaction request from the user.

In one embodiment: the speech processing system is configured to: interpret the speech command data to identify a command; generate command data indicative of the command; in the interaction processing system is configured to: obtain the command data; use the command data to identify a content interaction; and, perform the content interaction.

In one embodiment: the interaction processing system is configured to: obtain content code from a content processing system in accordance with a content address, the content code representing content that can be displayed; obtain interface code from an interface processing system at least partially in accordance with the content address, the interface code being indicative of an interface structure; construct a speech interface by populating the interface structure using content obtained from the content code; generate interface data indicative of the speech interface; the speech processing system is configured to: receive the interface data; and, generate the speech interface data using the interface data.

In one broad form, an aspect of the present invention seeks to provide a method for processing content to allow user interaction with the content, the method including, in an interaction processing system including one or more electronic processing devices: obtaining content code representing content that can be displayed; obtaining interface code indicative of an interface structure; parsing the content code to determine a content condition associated with at least part of the content; using the content condition to construct an interface by populating the interface structure using content obtained from the content code; generating interface data indicative of the interface; and, providing the interface data to a user interface system to allow the user interface system to present an interface including content from the content code to allow user interaction with the content.

In one broad form, an aspect of the present invention seeks to provide a computer program product for processing content to allow user interaction with the content, the computer program product including computer executable code, which when executed by one or more suitably programmed electronic processing devices of an interaction processing system, causes the interaction system to: obtain content code representing content that can be displayed; obtain interface code indicative of an interface structure; parse the content code to determine a content condition associated with at least part of the content; use the content condition to construct an interface by populating the interface structure using content obtained from the content code; generate interface data indicative of the interface; and, provide the interface data to a user interface system to allow the user interface system to present an interface including content from the content code to allow user interaction with the content.

In one broad form, an aspect of the present invention seeks to provide a system for presenting content, the system including an interaction processing system, including one or more electronic processing devices that are configured to: obtain content code representing content that can be displayed; retrieve processing rules; process the content in accordance with the processing rules to generate processed content; generate interface data indicative of an interface using the processed content; and, provide the interface data to a user interface system to allow the user interface system to present an interface including processed content.

In one embodiment the processing rules define a template for interpreting the content.

In one embodiment the one or more processing devices are configured to: determine a content type of at least part of the content; and, process the at least part of the content using the content type.

In one embodiment the part of the content is at least one of: a section; and, an element.

In one embodiment the one or more processing devices are configured to: identify tags associated with the content from the content code using a query language; and, use the tags to determine a content type of at least part of the content.

In one embodiment the query language is XPath.

In one embodiment the one or more processing devices are configured to: determine a content condition; and, process the at least part of the content using the content condition.

In one embodiment the one or more processing devices are configured to: identify navigation elements from the content code; and, construct the interface using the navigation elements.

In one embodiment the one or more processing devices are configured to identify the navigation elements from a menu structure.

In one embodiment the one or more processing devices are configured to: determine an interface structure using the processing rules and content code; and, construct the interface by populating the interface structure using content from the content code.

In one embodiment the one or more processing devices are configured to: determine object content by constructing an object model indicative of the content from the content code; and, process the object content.

In one embodiment the content includes a form and wherein the form is used to define an interface structure.

In one embodiment the content includes content fields and wherein the one or more processing devices are configured to at least partially populate the content fields.

In one embodiment the one or more processing devices are configured to: retrieve user data; and, process the content by populating content fields using the user data.

In one embodiment the one or more processing devices are configured to: identify at least one field in the content code; and, populating the field using the user data.

In one embodiment the one or more processing devices are configured to: submit processed content to a content processing system; obtain further content code representing further content that can be displayed; and, generate the interface using the further content.

In one embodiment the one or more processing devices are configured to: use the processing rules to generate stylization data; and, generate the interface data using the stylization data.

In one embodiment the content code includes style code, and wherein the one or more processing devices are configured to: use the style code to generate stylization data; and, generate the interface data using the stylization data.

In one embodiment the one or more processing devices are configured to process the content to at least one of: exclude content from the interface; include content in the interface; substitute content for the interface; and, add content to the interface.

In one embodiment the one or more processing devices are configured to: receive an interaction request from a user interface system; and, obtain the content code in accordance with the interaction request.

In one embodiment the one or more processing devices are configured to: obtain interface code at least partially in accordance with the interaction request, the interface code being indicative of an interface structure; and, populate the interface structure using content obtained from the content code.

In one embodiment the processing rules include executable code and wherein the one or more processing devices are configured to: use the executable code to modify the content to generate modified content such that the processed content includes the modified content; generate interface data indicative of an interface using the modified content; and, provide the interface data to a user interface system to allow the user interface system to present an interface including modified content.

In one embodiment the one or more processing devices are configured to modify the content by at least one of: removing content; adding content; and, replacing content.

In one embodiment the one or more processing devices are configured to: obtain interface code at least partially indicative of an interface structure; construct an interface by populating the interface structure using the modified content; and, generate the interface data using the populated interface structure.

In one embodiment the one or more processing devices are configured to: determine object content by constructing an object model indicative of the content from the content code; and, modify the object content.

In one embodiment the one or more processing devices are configured to use a browser application to: obtain content code; parse the content code to construct an object model; execute the executable code to modify the content; update the object model in accordance with the modified content; and, generate the interface data using the updated object model.

In one embodiment the executable code is at least one of: embedded within the content code; and, injected into the content code.

In one embodiment the one or more processing devices are configured to: receive a content request from a user interface system; and, in accordance with the content request, obtain at least one of: the content code; the executable code; and, interface code at least partially indicative of an interface structure.

In one embodiment the one or more processing devices are configured to: determine a content type of at least part of the content; and, obtain the executable code at least in part using the content type.

In one embodiment the part of the content is at least one of: a section; and, an element.

In one embodiment the one or more processing devices are configured to: identify tags associated with the content from the content code using a query language; and, use the tags to determine a content type of at least part of the content.

In one embodiment the query language is XPath.

In one embodiment the one or more processing devices are configured to: determine a content condition; and, obtain the executable code at least in part using the content condition.

In one embodiment the one or more processing devices are configured to: use the executable code to generate stylization data; and, generate the interface data using the stylization data.

In one embodiment the interface is a speech interface and wherein the user interface system presents audible speech output indicative of at least the content using a speech driven client device.

In one embodiment the user interface system includes a speech processing system that is configured to: generate speech interface data; provide the speech interface data to a speech enabled client device, wherein the speech enabled client device is responsive to the speech interface data to: generate audible speech output indicative of a speech interface; detect audible speech commands indicative of a user input; and, generate speech command data indicative of the speech commands; receive speech command data; and, use the speech command data to at least one of: identify a user; and, determine a service interaction request from the user.

In one embodiment: the speech processing system is configured to: interpret the speech command data to identify a command; generate command data indicative of the command; in the interaction processing system is configured to: obtain the command data; use the command data to identify a content interaction; and, perform the content interaction.

In one embodiment: the interaction processing system is configured to: obtain content code from a content processing system in accordance with a content address, the content code representing content that can be displayed; obtain interface code from an interface processing system at least partially in accordance with the content address, the interface code being indicative of an interface structure; construct a speech interface by populating the interface structure using content obtained from the content code; generate interface data indicative of the speech interface; the speech processing system is configured to: receive the interface data; and, generate the speech interface data using the interface data.

In one broad form, an aspect of the present invention seeks to provide a method for presenting content, the method including, in one or more electronic processing devices of an interaction processing system: obtaining content code representing content that can be displayed; retrieving processing rules; processing the content in accordance with the processing rules to generate processed content; generating interface data indicative of an interface using the processed content; and, providing the interface data to a user interface system to allow the user interface system to present an interface including processed content.

In one broad form, an aspect of the present invention seeks to provide a computer program product for presenting content, the computer program product including computer executable code, which when executed by one or more suitably programmed electronic processing devices of an interaction processing system, causes the interaction system to; obtain content code representing content that can be displayed; retrieve processing rules; process the content in accordance with the processing rules to generate processed content; generate interface data indicative of an interface using the processed content; and, provide the interface data to a user interface system to allow the user interface system to present an interface including processed content.

In one broad form, an aspect of the present invention seeks to provide a system for presenting content, the system including an interaction processing system, including one or more electronic processing devices that: obtain content code representing content that can be displayed; obtain executable code; use the executable code to modify the content to generate modified content; generate interface data indicative of an interface using the modified content; and, provide the interface data to a user interface system to allow the user interface system to present an interface including modified content.

In one broad form, an aspect of the present invention seeks to provide a method for presenting content, the method including, in one or more electronic processing devices of an interaction processing system: obtaining content code representing content that can be displayed; obtain executable code; use the executable code to modify the content to generate modified content; generating interface data indicative of an interface using the modified content; and, providing the interface data to a user interface system to allow the user interface system to present an interface including modified content. A computer program product for presenting content, the computer program product including computer executable code, which when executed by one or more suitably programmed electronic processing devices of an interaction processing system, causes the interaction system to: obtain content code representing content that can be displayed; obtain executable code; use the executable code to modify the content to generate modified content; generate interface data indicative of an interface using the modified content; and, provide the interface data to a user interface system to allow the user interface system to present an interface including modified content.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:—

FIG. 1A is a flowchart of an example of a process for interpreting speech input;

FIG. 1B is flow chart of an example of a process for facilitating speech enabled user interaction with content;

FIG. 1C is a flow chart of an example of a process for processing content to allow user interaction with the content;

FIG. 1D is a flow chart of an example of a process for presenting content;

FIG. 1E is a flow chart of an example of a process for presenting content:

FIG. 2 is a schematic diagram of an example distributed computer architecture;

FIG. 3 is a schematic diagram of an example of processing system;

FIG. 4 is a schematic diagram of an example of a client device;

FIG. 5 is a schematic diagram illustrating the functional arrangement of a system for allowing a user to interact with a secure service:

FIGS. 6A and 6B is a flow chart of an example of a process for performing a user interaction with content:

FIGS. 7A and 7B are a specific example of a process for interpreting speech input:

FIG. 8 is a flowchart of a further specific example of a process for interpreting speech input;

FIG. 9 is a further specific example of a flowchart for interpreting speech input;

FIGS. 10A to 10C are a flow chart of a further example of a process for performing speech enabled interaction with content;

FIGS. 11A and 11B are a flow chart of a specific example of a process for processing content to allow user interaction with the content;

FIGS. 12A to 12C are a flow chart of a specific example of a process for presenting content; and,

FIGS. 13A and 13B are a flow chart of a specific example of a process for presenting content.

### DETAILED DESCRIPTION OF THE PREFERRED EMBODIMENTS

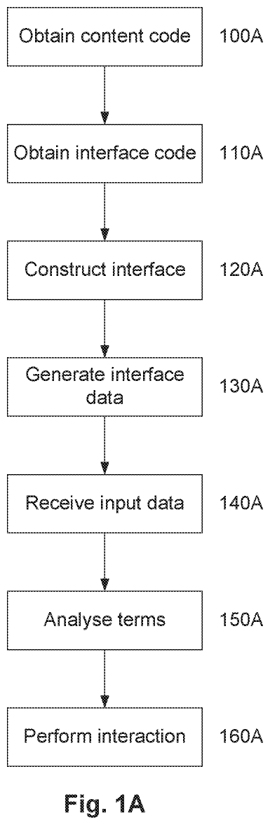

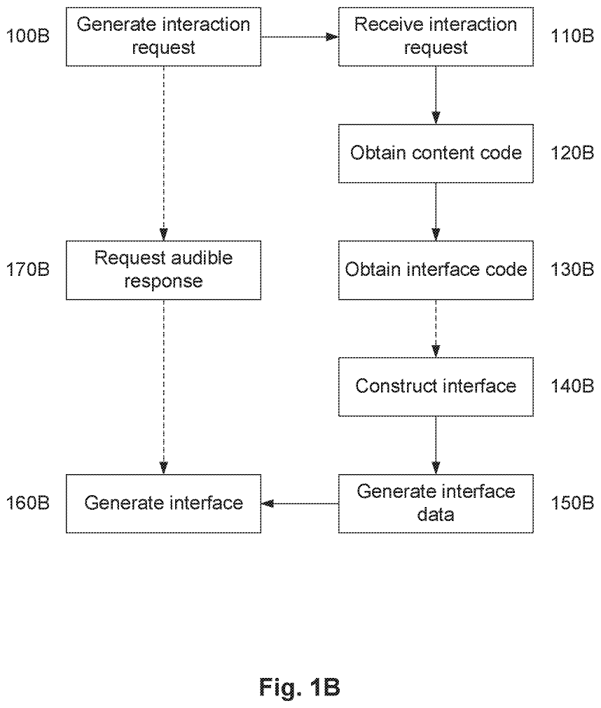

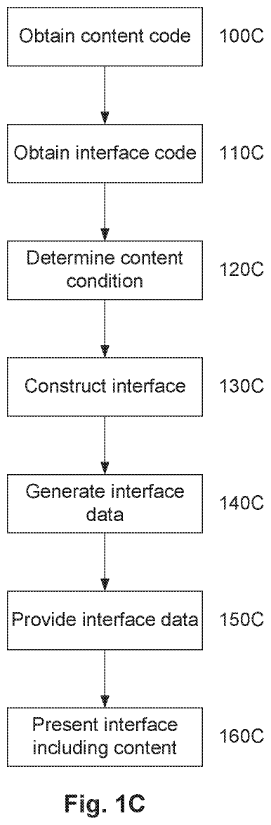

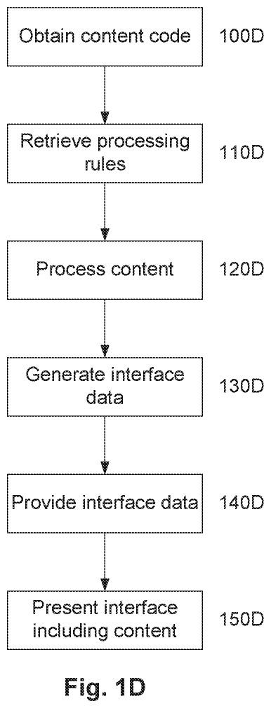

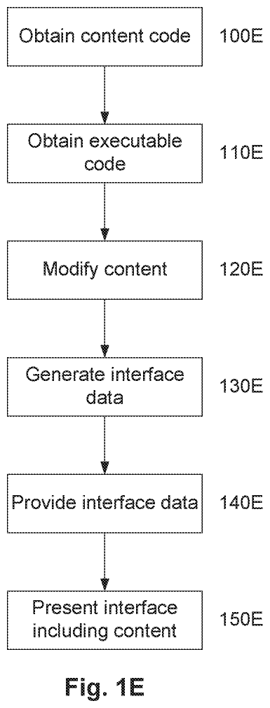

Examples of processes for use in performing speech interactions, such as interpreting speech input, performing speech enabled user interaction or the like, will now be described with reference to FIGS. 1A to 1E.

For the purpose of illustration, it is assumed that the processes are performed at least in part using one or more electronic processing devices forming part of one or more processing systems, such as computer systems, servers, or the like, which are in turn connected to other processing systems and one or more client devices, such as mobile phones, portable computers, tablets, or the like, via a network architecture, as will be described in more detail below.

For the purpose of this example, it is assumed that the processes are implemented using a suitably programmed interaction processing system that is capable of retrieving and interacting with content hosted by a remote content processing system, such as a content server, or more typically a web server. The interaction processing system can be a traditional computer system, such as a personal computer or laptop, could be a server, or could include any device capable of retrieving and interacting with content, and the term should therefore be considered to include any such device, system or arrangement.

For the purpose of these examples, it is assumed that the interaction processing system, includes one or more electronic processing devices, and is capable of executing one or more software applications, such as a browser application and an interface application, which in one example could be implemented as a plug-in to the browser application. The browser application mimics at least some of the functionality of a traditional web browser, which generally includes retrieving and allowing interaction with a webpage, whilst the interface application is used to create a user interface. Whilst the browser and interface applications can be considered as separate entities, this is not essential, and in practice the browser and interface applications, could be implemented as a single unified application. Furthermore, for ease of illustration the remaining description will refer to a processing device, but it will be appreciated that multiple processing devices could be used, with processing distributed between the devices as needed, and that reference to the singular encompasses the plural arrangement and vice versa.

It is also assumed that the interaction processing system is capable of interacting with a user interface system that is capable of presenting the interface generated by the interface application. In one example, the interface system includes a speech enabled client device, such as a virtual assistant, which can present audible speech output and receive audible speech inputs, and an associated speech processing system, such as a speech server, which interprets audible speech inputs and provides the speech enabled client device with speech data to allow the audible speech output to be generated. It will be appreciated that the virtual assistant could include a hardware device, such as an Amazon Echo or Google Home speaker, or could be implemented as software running on a hardware device, such as a smartphone, tablet, computer system or similar. It will be appreciated from the following however, that this is not essential and other interface arrangements, such as the use of a stand-alone computer system, could also be used.

An example of a process for interpreting speech input will now be described with reference to FIG. 1A.

In this example, at step 100A, the interaction processing system obtains content code representing content that can be displayed, before obtaining interface code indicative of an interface structure at step 110A. These steps are typically performed in response to a user request, for example, by having the user make an audible request via the interface system. The interaction request is typically indicative of content with which the user wishes to interact, and typically includes enough detail to allow the content to be identified. Thus, the interaction request could an indication of a content address, such as a Universal Resource Locator (URL), or similar, with this being used to retrieve the content and/or interface code.

The nature of the content and the content code will vary depending on the preferred implementation. In one example, the content is a webpage, with the content code being HTML (HyperText Markup Language), or the like. In this instance, the content is obtained from a content server, such as a web server, allowing the content code to be retrieved using a browser application executed internally by the interaction processing system, although it will be appreciated that other arrangements are feasible.

The interface code could be of any appropriate form but generally includes a markup language file including instructions that can be interpreted by the interface application to allow the interface to be presented. The interface code is typically developed based on an understanding of the content embodied by the content code, and the manner in which users interact with the content. The interface code can be created using manual and/or automated processes as described further in copending application WO2018/132863, the contents of which is incorporated herein by cross reference.

At step 120A uses the content code and interface code to construct an interface. The manner in which this is achieved will vary depending on the preferred implementation, however, typically the interaction processing system constructs an interface by populating an interface structure defined in the interface code using content obtained from the content code. In particular, the interaction processing system determines object content by constructing an object model indicative of the content from the content code. The object model typically includes a number of objects, each having associated object content, with the object model being usable to allow the content to be displayed by the browser application. The object model is normally used by a browser application in order to construct and subsequently render the webpage as part of a graphical user interface (GUI), although this step is not required in the current method. From this, it will be appreciated that the object model could include a DOM (Document Object Model), which is typically created by parsing the received content code. The object content is then used to populate the interface structure. For example, any required object content needed to present the interface, which is typically specified by the interface code, can be obtained from the browser application.

Interface data indicative of the resulting speech interface can then be generated at step 130A, and provided to the user interface system, allowing the user interface system to generate an interface.

At step 140A, input data is received from the interface system with the input data being generated in response to audible user speech input relating to the content interaction. The input data is typically indicative of one or more terms identified using speech recognition techniques. Thus an audible speech input is provided and converted using speech recognition techniques into one or more terms. The nature of the terms will vary depending upon the preferred implementation, but typically these are natural language words although other terms, such as phonemes could be provided, depending on the particular implementation of the speech recognition process.

At step 150A the terms are analysed with this being used to determine an interpreted user input. The nature of the analysis and the manner in which this is performed will vary depending upon the preferred implementation, and could include converting terms such as phonemes, to natural words, performing word matching mentioned techniques, examining interface context or previously stored data or the like, in order to identify uncertain terms. Once the interpreted user input has been identified, this can be used to perform interaction with the content.

Accordingly, the above described process operates by generating an interface based on content and interface code, allowing the interface code to be used to interpret the content code. Once the interface has been presented, speech is detected and recognised using normal existing speech recognition techniques. Terms indicative of the recognised speech then undergo a further stage of analysis in order to reduce ambiguity in the recognised speech input. A variety of different analysis techniques can be implemented depending on the preferred implementation, but irrespective of the technique used, reducing the ambiguity in the input in this manner ensures that interactions performed with the content are performed accurately and in accordance with desired instructions. Accordingly, it will be appreciated that this provides a solution to the technical problem of ensuring accuracy of speech recognition results, whilst avoiding the need to use solutions, such as personalised speech recognition, which is particularly difficult for systems having large numbers of users.

A number of further features will now be described.

In one example, the interaction processing system causes the interface system to obtain a user response confirming if the interpreted user input is correct. This process is performed in order to verify the interpretation of the speech input prior to any interaction being commenced. This can avoid misinterpreted interactions being performed, which can be frustrating for the user, and more importantly from a technical perspective, can avoid wasting valuable computational resources performing interactions that are not required.

In order to achieve this, the interaction system typically generates request data based on the interpreted user input and then provides the request data to the interface system to cause the interface system to generate audible speech output indicative of the interpreted user input. The interface system is then used to determine an audible user input indicative of a response, which is in turn used to generate input data that is provided back to the interaction processing system, allowing the interaction processing system to confirm the interpretation is correct and perform the interaction accordingly. Thus, this process could involve having the user interface say “we believe that you said the following” with the user merely being required to say “yes” or “no”, which can be easily recognised.

As a further alternative, it is possible for the interaction processing system to determine multiple possible interpretations of a user input, and then have the interface system obtain a user response confirming which interpretation is correct. For example, the interface system can be configured to present three possible interpretations to the user, using the interface system, and then ask the user to verbally confirm a response option, for example by speaking a number such as “one”, “two” or “three”, which can again be easily recognised, thereby removing any ambiguity.

In one example, in order to assist with interpreting the input terms, the interaction processing system can identify an instruction and then analyse the terms in accordance with the instruction to determine the interpreted user input. The instructions can guide the nature of the analysis and/or the manner in which is this is performed, and it will be appreciated that a wide variety of instructions could be used. For example, the instruction could be that the speech input corresponds to spelled word. In this instance, the input terms received from the interface system would typically be in the form of natural words corresponding to letters, for example, “Ay”, “Bee” or “Sea” corresponding to the letters “A”, “B”, “C”, phonemes corresponding to phonetic sounds, or words or phrases representing particular letters, such as “Alfa”, “Bravo”, “Charlie”, with these being used to allow the word to be reconstructed. Instructions could be single instructions, or could be composite instructions, for example s that the user speaks a word and spells the word.

In examples in which instructions are used, the interaction processing system can identify the instructions either from the interface or interface data, or using the input terms. For example, the interface may instruct the user to spell a response, for example if it is known from the interface or content that the response is likely to be difficult to interpret. Thus, in this instance, the interface could be presented with a statement “Please spell your first name and then last name”. Alternatively, the user can choose to spell the response by providing a spell command at the start of any speech input, for example by providing a response “My name is John, spelt J-O-H-N” or “My name is John, spelt Juliett Oscar Hotel November”.

In the circumstances in which the instruction is to spell the word, the interaction processing system can cause the interface system to generate audible speech indicative of the spelling and then obtain a user response confirming if the spelling is correct, for example, by saying “We believe your name is John, spelt J-O-H-N, is that correct?”. Thus in this instance the interface system will spell the word to the user and have the user confirm that is correct in order to ensure the input is correctly interpreted. In general, the confirmation can be presented in any appropriate manner, which may for example be defined as part of user preferences. For example, this could include saying the term, spelling the term, or a combination of the two, as described above.

As an alternative to the input terms being indicative of a spelling, the input terms could be indicative of an identifier indicative of a previous stored user input. For example, the user could store information with the interaction processing system, and then when asked to provide information, could provide an instruction to have the interaction processing system retrieve the stored information. For example, the user could select to store multiple addresses, such as a home or work address. In this instance, when the interface asks the user to provide an address, the user could respond by saying “please use my saved work address”. In this instance, the “please use my saved” wording, can used as an instruction, causing the interaction processing system to retrieve the user's work address and use that as an input. In a further example, input interpretation could be performed in accordance with user preferences, for example, to retrieve stored details, such as a name, and use this to interpret a spoken command. So, if the user states that “My name is John”, the system could retrieve previously stored name data to confirm if the name should be spelt John or Jon.

Additionally and/or alternatively, the interaction processing system can perform an analysis by comparing input terms to the interface code, the content code, the content or the interface, for example by examining context associated with the content or interface in order to avoid ambiguity. A further example, is to compare the input to previously stored data, for example, associated with a respective user profile. Results of the comparison are then used to determine the interpreted user input. In particular, this process can be performed using techniques such as a word or phrase matching, fuzzy logic or fuzzy matching, context analysis, or the like, in order to identify one or more closest matches for corresponding terms in the interface or content. For example, a Levenshtein distance algorithm or other similar algorithm could be used in order to determine a degree of similarity between an input term and corresponding terms in the content or interface.

In one example, in order to achieve this, the interaction processing system identifies a number of potential interpreted user inputs, calculates a score for each potential interpreted user input, for example using the distance algorithm, and then determines the interpreted user input by selecting one or more of the potential user inputs using the calculated scores. Thus, for example, a single match could be selected so that the interpreted user input is based on the potential interpreted user input with the highest score. Alternatively, a set number of interpreted user inputs, such as the top three scores, or any with a score over a threshold, could be selected and presented to the user, allowing the user to confirm the correct interpretation.

In one example, the interaction processing system receives an indication of a user identity from the interface system and perform analysis of the terms at least in part using stored data associated with the user using the user identity. Specifically, the stored data can be associated with an interaction system user account linked to an interface system user account. In this instance, the user interface determines the user identity using the user interface system user account, typically by performing voice recognition and/or taking into account a client device used by the user. This can be used to retrieve stored data from the interaction system user account of the user, which could include information, such as personal details, details of commonly used terms or similar. Once this has been performed, the user input terms can be compared to the stored data to determine if this can resolve an ambiguity, for example to ensure the correct spelling of the user's name and/or address.

Typically, the interaction processing system receives an interaction request from a user interface system, the interaction request being provided as user input, and then obtains the content code and interface code at least partially in accordance with the interaction request. In one example, the content code and interface code are obtained in accordance with a content address.

An example of performing speech enabled user interaction with content will now be described with reference to FIG. 1B.

In this example, at step 100B, an interaction request is generated by a user interface system and provided to the interaction processing system at step 110B. This is typically performed in response to a user request, for example, by having the user make an audible request via the interface system, as described above with respect to steps 100A and 110A.

At steps 120B to 150B, the processing device obtains content code and content code in accordance with the interaction request, and uses these to construct an interface and generate interface data, allowing an interface to be generated at step 160B. In particular, in one example, the interface is generated by converting the interface data to speech data, which can then be used to generate audible speech output indicative of the speech interface.

These steps are substantially identical to steps 100A to 130A described above and these will not therefore be described in further detail.

The above described process may take a significant amount of time due to the need to retrieve and process the content code. For example, the content code may be complex and may need to be generated on demand in response to user inputs, which can take time. As previously described, such delays can be problematic. For example, speech enabled user interaction is typically intended to be conversational in style, meaning that delays are undesirable. In particular, this results in the content presentation being disjointed, which makes it difficult for a user to maintain concentration. Additionally, and more problematically, speech enabled interaction sessions are typically adapted to timeout after a timeout period, such as five seconds, to enable load sharing of resources to be performed. Accordingly, in many cases, the delay between the interaction request being received by the user interface system at step 110, and the interface data being generated at set 150 is often greater than the timeout period, meaning the session times out and the interface is never actually presented.

Accordingly, in order to avoid this issue, audible responses can be requested from a user at step 170B, with this occurring after the interaction request has been provided at step 100B, but before the interface is generated, and more particularly before the timeout occurs. The audible response request is used to avoid the technical issue associated with the timeout, but has the added benefit of maintaining a conversational appearance to the interaction process.

The nature of the audible response requested could vary depending upon the preferred implementation, and may simply be informing the user that a delay is occurring and asking them to confirm they wish to continue waiting. Alternatively, the response request may ask the user to confirm the original interaction request is correct, or may request information from the user that is to be used in subsequent interactions, as will be described in more detail below.

In any event, it will be appreciated that this mechanism avoids the problems associated with timeouts and can allow conversations to occur in a more conversational manner.

A number of further features will now be described.

In one example, the interaction processing system provides request data to the user interface system to cause the user interface system to request the audible response. This mechanism allows the request and response process to be controlled by the interaction server, allowing the interaction server to make use of this process, for example to avoid unnecessary requests, or to request information that may be required during completion of a form or similar. This allows the response request to be used in a meaningful manner, and in particular can be used to streamline downstream processes, which in turn can make the overall interaction experience with the content more seamless, as will be described in more detail below.

In one example, the request data can be based on the interaction request, for example to have the user confirm the nature of the interaction request is correct, and/or that this has been correctly interpreted by the speech enabled user interface system. In this example, the interaction processing system generates request data indicative of the interaction request, with the user interface system being responsive to the request data to request user confirmation the interaction request is correct, via a speech enabled client device. This can be useful, as sometimes errors arise in interpreting user speech inputs, which can result in an incorrect interaction request being actioned. Accordingly, by having the user confirm the interaction request is correct, this avoids incorrect interaction requests being actioned, but also serves to avoid timeouts and maintain conversational interaction, whilst waiting for the content code to be retrieved.

Alternatively, the request data can be generated based on the interface code, for example to allow the interaction system to request information that will be used later on in the interaction process. For example, if the user requests to access a travel planner website, the response request could include asking the user for travel details, such as a destination, preferred mode of travel, departure time, or the like. The knowledge of such downstream requirements can be obtained from the interface code, which typically embodies a workflow indicative of interaction with the respective content, and hence includes information regarding inputs that will be required later on during the interaction process. Requesting this information upfront allows this information to be reused later when time delays in preparing and presenting user interfaces are less problematic, and for example allows forms to be pre-populated, avoiding the need for requests to be made subsequently. This can streamline downstream processes, making interaction with the content seem more natural.

Thus, in one particular example, the content can include a form, with the interface code specifying the fields of the form, and hence the information that will be needed from the user in order to complete the form. Accordingly, in this instance, the interaction processing system can determine form responses required to complete the form using the interface code and then generate request data indicative of the form responses. In this instance, the request data can be used to allow the user interface device to request user responses via a speech enabled client device and then generate response data indicative of the user responses. The response data can be returned to the interaction processing system, allowing this to be used to determine the user's form responses and populate the form with the responses at an appropriate time.

In a further example, predefined request data can be retrieved. In this case, it will be appreciated that the request data could relate to one or more predefined requests, such as a default statement indicating to a user that the process is in progressing and that a response will be provided as soon as possible.

In one example, response requests can be made in the event that these are required to prevent a timeout. Thus, the interaction processing system can be configured to determine a time to generate the interface data and then selectively generate response data depending on the time. Thus, the interaction processing system can monitor the process of retrieving content and ascertain whether responses are required to avoid a timeout, generating responses only in the event that these are required.

In order to achieve this, the processing system can monitor the time taken to retrieve content data and/or monitor the time taken to populate the interface structure. These approaches are reactive in the sense that action is taken only once it is determined that the timeout is to trigger based on actual events. However, additionally or alternatively, the system can be proactive, for example by predicting the time that will be taken to populate the interface structure or retrieve the content code. This can be based on extrapolation of current progress and/or could be based on historical data. For example, the interaction processing system could retrieve time data indicative of a previous time required to generate the interface data based on the content interaction requested, and use this to assess if a response is required. Thus, for example, each time a webpage is accessed, a response time could be monitored, with this being recorded and used to predict whether responses might be required in order to ensure that a timeout is avoided.

A process for presenting content will now be described with reference to FIG. 1C.

In this example, step 100C the interaction processing system obtains content code representing content that can be displayed before obtaining interface code indicative of an interface structure at step 110C. These steps are substantially similar to steps 100A and 110A and will not therefore be described in any further detail.

At step 120C, the interaction processing system parses the content code to determine a content condition associated with at least part of the content. The content condition could be any condition associated with some or all of the content defined in the content code, and could include a content presence or absence, such as a presence or absence of a specific content address, or particular fields or elements, a content element state, such as whether content is enabled, disabled, visible, hidden, or the like. For example, the content code might include content that is only to be presented in the event that certain criteria are satisfied, in which case the interaction process system can make an assessment of whether the criteria are satisfied and hence determine a condition of the associated content.

At step 130C, an interface is constructed by populating the interface structure using content obtained from the content code. Again this step is substantially similar to step 140A described above and will not therefore be described in any further detail.

However, in this example, the step of constructing the interface is typically performed taking into account the content condition, for example, allowing disabled content to be omitted, so that it is not presented to the user, thereby simplifying the resulting interface. In one example, this is achieved by determining an action associated with the respective content condition and then implementing the action when constructing the interface, and example processes will be described in more detail below.

Interface data indicative of the resulting speech interface can then be generated at step 140C, and provided to the user interface system at step 150C, allowing the user interface system to generate an interface at step 160C.

The nature of the user interface system will vary depending upon the preferred implementation. In one example the user interface system could include a speech based user interface system, including a speech processing system and/or a speech enabled client device which is capable of presenting an audible version of the content, although this is not essential and the process could be performed in order to generate and display visual content, for example to provide a visually simplified view of the webpage, making this easier to view.

Accordingly, the above described process operates by processing content based on a content condition and then constructing an interface taking the content condition into account, so that the interface can be customised based on the content condition. This makes the interface more relevant to the content, and in particular the current context, allowing the interface to be presented in a more effective manner, in turn allowing interactions to be performed more easily.

A number of further features will now be described.

In one example, the processing devices perform a content interaction and determine the content condition in response to performing the content interaction. For example, when the content includes a form, completing one section of the form may cause the user to be directed to omit following sections of the form and proceed to a later part of the form. In this instance, when the interaction processing system enters information into a web based form, and hence partially completes the form, the interaction system will examine how the content code changes, and in particular identify parts of the form which are now disabled, modifying the presentation of subsequent parts of the form in order to streamline the form completion process. Thus, in one example, the processing devices obtain updated content code as a result of the content interaction, parse the updated content code to determine the content condition for subsequent parts of the form, and present later parts of the form accordingly. In one particular example, this allows the system to automatically skip parts of the form that do not need to be completed, making the form completion process far easier to perform.

In another example, the processing devices determine the content type of at least part of the content and determine the content condition at least in part using the content type. For example, certain types of content may have a respective condition, which could be fixed or could be dependent on other factors, such as being specified in the content code, with this being used to control the content presentation.

Thus, for a form, the form might include spouse fields, and whether these fields are enabled depends on a response to a prior marital status question. In this example, the field types can therefore be used in conjunction with a previous response to ascertain the field condition, and hence whether the fields should be displayed.

However, it will also be appreciated that the content type could be used to determine a content condition in a wide variety of different manners, and this example is not intended to be limiting. For example, the content condition could be determined taking into account user preferences, or the like. In this instance, the user might define that they do not wish to be presented with content relating to certain topics, so the content condition could be ascertained as disabled in the event that the content relates to the topics specified by the user, allowing the system to proceed to present content of interest to the user. In another example, the content type could include a link to another webpage, in which case content from the other webpage may need to be presented.

The content type could be determined in any one of a number of ways but typically this can be achieved by identifying tags associated with content from the content code, such as HTML tags, and then using the tags to determine the content type. Applicable tags may be identified using any query language, such as XPath, which can then be used to identify elements and attributes from the content code. The content type could include sections of a website and/or specific types of elements, such as graphical elements, allowing the technique to be applied to entire sections of a website, individual elements, graphical content, or the like.

In one example, the processing devices use a content condition to determine an action, then performing the action in order to process the content. A wide range of different actions could be performed, depending on the circumstances in which the approach is used, and the nature of the content.

In one example, the action includes modifying the interface structure. In this regard, the interface structure sets out how the content should be presented, so that the interface structure could be modified, allowing content to be presented differently, for example, allowing additional content to be integrated into the interface, or allowing an interface order to be changed. Alternatively, the action could include navigating the interface structure, for example jumping to a later task in the interface structure, in the event that intervening tasks could be omitted.

Similarly, the action could include modifying the content, for example replacing the content with alternative content, navigating the content, for example to skip to later content or start presenting content at a particular location on a webpage, selecting content to exclude from, or include in, the interface, or the like. The action could also include re-directing to other content or the like. As previously mentioned, in one particular example, when the content includes a form, wherein the processing devices parse the content to determine a form field condition indicative of whether the form field is enabled then if the form field is enabled, present an interface including the form field, whereas if the form field is disabled, the interface omits the form field.

The manner in which the action is implemented can also be varied depending on the preferred implementation.

In one example, the interaction processing system uses the content condition to obtain executable code. The executable code can be of any appropriate form, but in one example is a script, such as JavaScript or the like, which is executed by a JavaScript engine implemented by the interaction processing system, typically using an internally hosted browser application. The executable code can be obtained in any manner and could be retrieved from local storage, or the like. The executable code typically defines how the content and/or content code should be modified in order to simplify the content for presentation. In one example, the executable code defines content substitutions, additions or removals, which can be applied to a webpage in order to simplify the content for presentation. For example, this could include replacing an image with content explaining the content of the image.

In one example, the executable code can be sufficiently generic that it can be applied to a wide range of different webpages. However this is not essential, and alternatively, the executable code could be adapted to operate for particular content or particular types of content, so that the executable code can be applied any webpages including such content or types of content. For example, the executable code could be adapted to replace images with text, or to replace particular phrases with more readily understood content. The executable code could also be adapted to perform other operations on content, such as translation of the content, or similar.

The interaction processing system can then modify the content by executing the executable code, which in one example involves injecting the executable code into the content code, to thereby modify the resulting content. In one particular example, this is achieved by generating modified object code using the executable code and then generating the interface using the modified object code.

Accordingly, in this example, the process operates by applying using executable code to modify the content embodied by content code, and then generate an interface using the modified content. The executable code can be applied broadly across a number of different webpages, for example by selecting the executable code based on the type of content contained within a webpage. The executable code typically simplifies the content, in particular, removing extraneous content, replacing content that cannot be easily presented, for example replacing graphical content with equivalent content with text, which can then be converted to speech, or the like.

In another example, the interaction processing system uses the content condition to retrieve processing rules. The processing rules can be of any appropriate form, but typically define how the content and/or content code should be processed in order to simplify the content for presentation. In one example, the processing rules define an overlay which can be applied to a webpage in order to simplify the content for presentation. The overlay can be of any form, but typically defines parts of the webpage, such as sections or elements, that should or should not be displayed. Additionally, and/or alternatively, the processing rules could define content that should be removed or replaced, or could define instructions for analysing the content or content code to identify structure associated with the content, which can then be used in generating an interface.

The processing rules can be sufficiently generic that these can be applied to a wide range of different webpages. In one example, processing rules can be defined for a website and applied to any webpage associated with the website. This is feasible, because there will typically be a high degree of consistency in layout and presentation for different webpages on any given website. However this is not essential, and many webpages or websites include common elements or sections and so processing rules can be derived which apply to multiple websites or webpages generically.

The processing rules are then applied to the content to generate processed content, which is then used to generate the interface. The processing rules can be applied broadly across a number of different webpages, avoiding the need for customised interface data to be generated for each of a number of different webpages. The processing rules typically simplify the content, in particular, removing extraneous content, replacing content that cannot be easily presented, for example replacing graphical content with equivalent content with text, which can then be converted to speech, or the like.

In one example, the processing rules define a template for interpreting the content. The template can, for example, specify sections of a webpage that should not be displayed, for example a header and/or footer sections. The template could be defined in any manner, for example based on a visual inspection of the website, an understanding of content in various sections of the website, or the like.

In a further example, the action can include generating stylisation data, allowing the interface to be generated using the stylisation data. The stylisation data can be generated in any appropriate manner and in one example this is performed based on identification of tags associated with content in the content code, with the tags being used to control presentation of the content. For example, greater emphasis can be given to content tagged with a “title” tag as opposed to “body” content, allowing the title content to be presented in a different manner. This can also be achieved using style code associated with or forming part of the content code, such as style sheets, cascading style sheets (CSS), or the like, which are used to control the manner in which HTML code is presented by a browser. In this instance, the processing rules can generate stylisation data based on style code, such as a CSS document associated with the content, and then use the stylisation data when generating and the interface data, so that the interface is presented in accordance with the respective stylisation.

As mentioned above, in one example the processing devices determine object content by constructing an object model indicative of the content from the content code. The object content can then be used to determine the content state or populate the interface.

Typically, the interaction processing system receives a content or interaction request from a user interface system, the interaction request being provided as user input, with the processing devices using the request to perform an interaction, obtain the content code or obtain the interface code.

A process for presenting content will now be described with reference to FIG. 1D.

In this example, step 100D the interaction processing system obtains content code representing content that can be displayed, in a manner substantially similar to that described above with respect to step 100A, and which will not therefore be described in further detail.

At step 110D, the interaction processing system retrieves processing rules. The processing rules can be of any appropriate form, but typically define how the content and/or content code should be processed in order to simplify the content for presentation. In one example, the processing rules define an overlay which can be applied to a webpage in order to simplify the content for presentation. The overlay can be of any form, but typically defines parts of the webpage, such as sections or elements, that should or should not be displayed. Additionally, and/or alternatively, the processing rules could define content that should be removed or replaced, or could define instructions for analysing the content or content code to identify structure associated with the content, which can then be used in generating an interface.

The processing rules can be sufficiently generic that these can be applied to a wide range of different webpages. In one example, processing rules can be defined for a website and applied to any webpage associated with the website. This is feasible, because there will typically be a high degree of consistency in layout and presentation for different webpages on any given website. However this is not essential, and many webpages or websites include common elements or sections and so processing rules can be derived which apply to multiple websites or webpages generically.

It will be appreciated from the above that the processing rules can be retrieved from a suitable data store and may be retrieved based on a content address of the content, including a high level domain name associated with a particular requested webpage, or may simply involve retrieving generic rules in the event that interface code for a specific webpage is not available.

At step 120D, the interaction processing system processes the content by applying the processing rules. The manner in which this is achieved will vary depending upon the preferred implementation but in one example, this involves applying the processing rules in a hierarchal manner to progressively simplify the content and then generate an interface structure which can be used for presenting the content. Thus, processing rules can be applied to progressively remove sections of a webpage, elements of a webpage, content from particular elements, or the like. This process will be described in further detail below.

At step 130D, the interaction processing system generates interface data. The interface data can be of any appropriate form but typically specifies the content that should be presented and the manner in which this is achieved.

In one example, the process of generating interface content involves constructing an interface by deriving an interface structure from the content code and then populating the interface structure with content, in a manner substantially similar to that described above with respect to step 120A.

The interface data can then be provided to a user interface system at step 140D allowing the user interface system to present an interface including process to content at step 150D. The nature of the user interface system will vary depending upon the preferred implementation. In one example the user interface system could include a speech based user interface system, including a speech processing system and/or a speech enabled client device which is capable of presenting an audible version of the content, although this is not essential and the process could be performed in order to generate and display visual content, for example to provide a visually simplified view of the webpage, making this easier to view.

Accordingly, the above described process operates by applying predefined processing rules to content in order to process the content and generate an interface. The processing rules can be applied broadly across a number of different webpages, avoiding the need for customised interface data to be generated for each of a number of different webpages. The processing rules typically simplify the content, in particular, removing extraneous content, replacing content that cannot be easily presented, for example replacing graphical content with equivalent content with text, which can then be converted to speech, or the like.

A number of further features will now be described.

In one example, the processing rules define a template for interpreting the content. The template can, for example, specify sections of a webpage that should not be displayed, for example a header and/or footer sections. The template could be defined in any manner, for example based on a visual inspection of the website, an understanding of content in various sections of the website, or the like.

In one example, the processing devices determine the content type of at least part of the content and process the part of the content using the content type. Thus, this could correspond to identifying if part of the content relates to a header or footer, and then excluding this from the content that is presented. The content type could be determined in any one of a number of ways but typically this can be achieved by identifying tags associated with content from the content code, such as HTML tags, and then using the tags to determine the content type. Applicable tags may be identified using any query language, such as XPath, which can then be used to identify elements and attributes from the content code. The content type could include sections of a website and/or specific types of elements, such as graphical elements, allowing the technique to be applied to entire sections of a website, individual elements, graphical content, or the like.

In one example, the processing devices can determine a content condition and process the content using the content condition. The content condition could be indicative of a range of factors, including, but not limited to the operating environment, the particular code structure used by the content code, or the like.

In one example, the interaction processing system operates to identify navigation elements from the content code and construct the interface using the navigation elements. The navigation elements could be of any appropriate form but typically trigger some form of interaction, and could therefore include menus, links to other parts of a webpage, or other webpages, or similar. Thus it will be appreciated that identifying elements of the site that perform navigation can allow an interface structure to be derived, allowing content to be presented in a manner that allows a user to navigate around a webpage using the interface.

The interaction processing system can determine an interface structure using the processing rules and the content code and then construct the interface by populating the interface structure using content from the content code. In one example this is achieved by determining object content by constructing an object novel indicative of the content from the content code and then processing the object content, although other approaches could be used.

The content can include a form, in which case the interface structure can be derived from the form, in particular by allowing the interface to include a series of questions corresponding to the form fields that that the user must complete. In this example, the interaction processing system can be configured to at least partially populate the form prior to the form being presented. This can be achieved by retrieving user data and processing the content by populating form fields using the user data. For example, if a form requires a user provide a name and address, this information can be pre-stored by the interaction processing system, allowing this to be retrieved and entered into the form. This avoids the need to present parts of the form that can be automatically completed, thereby significantly simplifying the presentation of content.

In a further example, it will be appreciated that processed content can be submitted to a content processing system, allowing further content code to be obtained. For example, if a webpage includes as form, the processing could involve completing the form using stored user data, and then submitting the completed form, allowing further content to be retrieved and presented.

In addition to processing the content and generating interface data, a further option is for the processing device to use processing rules to generate stylisation data, allowing the interface to be generated using the stylisation data. The stylisation data can be generated in any appropriate manner and in one example this is performed based on identification of tags associated with content in the content code, with the tags being used to control presentation of the content. For example, greater emphasis can be given to content tagged with a “title” tag as opposed to “body” content, allowing the title content to be presented in a different manner. This can also be achieved using style code associated with or forming part of the content code, such as style sheets, cascading style sheets (CSS), or the like, which are used to control the manner in which HTML code is presented by a browser. In this instance, the processing rules can generate stylisation data based on style code, such as a CSS document associated with the content, and then use the stylisation data when generating and the interface data, so that the interface is presented in accordance with the respective stylisation.

In general, the processing of content could include any one or more of excluding content from the interface, including content in the interface, substitute content and adding content to the interface.

Whilst the above described process allows content to be interpreted without the presence of interface code, this is not essential and it will be appreciated that the process could be used in conjunction with interface code. In this example, interface code can be determined in accordance with a content request, such as an interaction request, received from a user interface system with the interface code being indicative of an interface structure. The interface structure can then be populated using content from the content code.

Typically, the interaction processing system receives a content or interaction request from a user interface system, the interaction request being provided as user input.

In one example, the processing rules can include executable code, which can be used to modify content and an example of this will now be described with reference to FIG. 1E.

In this example, step 100E the interaction processing system obtains content code representing content that can be displayed, in a manner substantially similar to that described above with respect to step 100A, and which will not therefore be described in further detail.

At step 110E, the interaction processing system obtains executable code, which in one example, embodies a particular form of processing rule. The executable code can be of any appropriate form, but in one example is a script, such as JavaScript or the like, which is executed by a JavaScript engine implemented by the interaction processing system, typically using an internally hosted browser application. The executable code can be obtained in any manner and could be retrieved from local storage, could be embedded within the content code, or could be referenced in the content code, for example by using a function call or similar to invoke the executable code, with the executable code being retrieved from a remote store, such as a web server, or the like.

The executable code typically defines how the content and/or content code should be modified in order to simplify the content for presentation. In one example, the executable code defines content substitutions, additions or removals, which can be applied to a webpage in order to simplify the content for presentation. For example, this could include replacing an image with content explaining the content of the image.

In one example, the executable code can be sufficiently generic that it can be applied to a wide range of different webpages. In one example, executable code can be defined for a website and applied to any webpage associated with the website. This is feasible, because in many cases there will typically be a high degree of consistency in layout and presentation for different webpages on any given website. However this is not essential, and alternatively, the executable code could be adapted to operate for particular content or particular types of content, so that the executable code can be applied any webpages including such content or types of content. For example, the executable code could be adapted to replace images with text, or to replace particular phrases with more readily understood content. The executable code could also be adapted to perform other operations on content, such as translation of the content, or similar.

It will be appreciated from the above that the executable code can be retrieved from a suitable data store and may be retrieved based on a content address of the content, or may be retrieved based on simply involve retrieving generic rules in the event that interface code for a specific webpage is not available.

At step 120E, the interaction processing system modifies the content by executing the executable code, which in one example involves injecting the executable code into the content code, to thereby modify the resulting content.

In one particular example, the interaction processing system determines object content by constructing an object model indicative of the content from the content code, in a manner substantially similar to that described above with respect to step 120A.

At step 130E, the interaction processing system generates interface data. The interface data can be of any appropriate form but typically specifies the content that should be presented and the manner in which this is achieved. In one example, the process of generating interface content involves constructing an interface by deriving an interface structure from the content code and then populating the interface structure with content, in a manner substantially similar to that described above with respect to step 120A.

The interface data can then be provided to a user interface system at step 140E allowing the user interface system to present an interface including process to content at step 150E, in manner similar to that described above with respect to steps 140D and 150D.

Accordingly, the above described process operates by applying using executable code to modify the content embodied by content code, and then generate an interface using the modified content. The executable code can be applied broadly across a number of different webpages, for example by selecting the executable code based on the type of content contained within a webpage. The executable code typically simplifies the content, in particular, removing extraneous content, replacing content that cannot be easily presented, for example replacing graphical content with equivalent content with text, which can then be converted to speech, or the like.

A number of further features will now be described.

In one example, the interface is generated using interface code at least partially indicative of an interface structure, with the interface being constructed by populating the interface structure using the modified content and then generating the interface data using the populated interface structure. The interface code could be of any appropriate form but generally includes a markup language file including instructions that can be interpreted by the interface application to allow the interface to be presented. The interface code is typically developed based on an understanding of the content embodied by the content code, and the manner in which users interact with the content. The interface code can be created using manual and/or automated processes as described further in copending application WO2018/132863, the contents of which is incorporated herein by cross reference.

In this example, the processing device typically determines object content by constructing an object model indicative of the content from the content code and then modifying the object content. Specifically, in one preferred example, the processing device uses a browser application to obtain the content code, for example by requesting this from a content server, parses the content code to construct an object model, executes the executable code to modify the content and update the object model in accordance with the modified content. Once this has been performed the processing device can generate the interface data using the updated object model, specifically by populating the interface structure using content from the updated object model.

The executable code can be obtained in any appropriate manner. For example, the executable code can be embedded within the content code, allowing this to be executed as needed. In this example, an operator of the interaction system can make executable code available, allowing content hosts to incorporate the executable code into their current content, allowing the content to be presented in a more user friendly manner, for example using a speech interface.

In another example, the executable code is retrieved from a database or similar, and injected into the content code, prior to generating the interface. In one example, the processing device receives a content request, such as an interaction request from a user interface system, and then uses the content request to retrieve the content code, the executable code and/or the interface code, which is at least partially indicative of an interface structure. Typically this is performed in accordance with a content address contained in the content request, with the content address being used to retrieve the content code. Interface code and executable code specific to the content code can then also be retrieved, for example, from a database local to the interaction processing system, again using the content address.

In another example, the processing devices determine the content type of at least part of the content and obtain the executable code at least in part using the content type. For example, certain types of the content, such as images, may need to be replaced, in which case executable code adapted to replace images could be used. Similarly, if the content includes foreign language content, the executable code could be configured to replace the content with translated content. In this instance, it will be appreciated that the executable code could be applicable to a wide range of different content, and hence retrieving the executable code using the content type allows the same executable code to be re-used across lots of different content.

The content type could be determined in any one of a number of ways but typically this can be achieved by identifying tags associated with content from the content code, such as HTML tags, and then using the tags to determine the content type. Applicable tags may be identified using any query language, such as XPath, which can then be used to identify elements and attributes from the content code. The content type could include sections of a website and/or specific types of elements, such as graphical elements, allowing the technique to be applied to entire sections of a website, individual elements, graphical content, or the like.

In one example, the processing devices can determine a content condition and obtain the executable code using the content condition. The content condition could be indicative of a range of factors, including, but not limited to the operating environment, the particular code structure used by the content code, or the like.

In addition to modifying the content and generating interface data, a further option is for the processing device to use the executable code to generate stylisation data, allowing the interface to be generated using the stylisation data. The stylisation data can be generated in any appropriate manner and in one example this is performed based on identification of tags associated with content in the content code, with the tags being used to control presentation of the content. For example, greater emphasis can be given to content tagged with a “title” tag as opposed to “body” content, allowing the title content to be presented in a different manner. This can also be achieved using style code associated with or forming part of the content code, such as style sheets, cascading style sheets (CSS), or the like, which are used to control the manner in which HTML code is presented by a browser. In this instance, the processing rules can generate stylisation data based on style code, such as a CSS document associated with the content, and then use the stylisation data when generating and the interface data, so that the interface is presented in accordance with the respective stylisation.

In general, the modification of content could include any one or more of excluding content from the interface, including content in the interface, substitute content and adding content to the interface.

In the above described arrangement, the interaction processing system typically operates to generate an interface, which can then be presented via the user interface system. This is performed as described above, by retrieving content code and modifying the content using the executable code, to thereby generate interface data. The interface data can then be provided to the speech processing system, which receives the interface data and uses this to generate the speech interface data, specifically by generating speech statements, which can be presented by a speech enabled client device to present an audible speech output indicative of the content and structure of the user interface.

In one particular example, the user interface system includes a speech processing system that generates speech interface data and provides the speech interface data to a speech enabled client device. The speech enabled client device is responsive to the speech interface data to generate audible speech output indicative of a speech interface, detect audible speech inputs indicative of a user input, such as a user response, and then generate speech input data indicative of the speech inputs.

The speech processing system then receives the speech input data from the speech enabled client device and uses the speech input data to identify an interaction request from the user. For example, this typically includes interpreting the users recorded speech into words, and then understanding from the words the request the user is making.

Accordingly, it will be appreciated that in one particular embodiment, the above described arrangement represents a virtual assistant, which includes a speech enabled client device, such as Google Home Assistant, and Amazon Echo device or similar, which interacts with a speech processing system, such as a Google or Amazon server, which in turn interprets inputs spoken by the user, and generates speech data, which is used to generate speech output.

In the above described arrangement, the interaction processing system typically operates to generate an interface, which can then be presented via the user interface system. This is performed as described above, by retrieving content code and interface code, and using the interface code to interpret the content code and generate interface data. The interface data can then be provided to the speech processing system, which receives the interface data and uses this to generate the speech interface data, specifically by generating speech statements, which can be presented by a speech enabled client device to present an audible speech output indicative of the content and structure of the user interface.

The speech processing system also typically interprets speech input data received from the speech enabled client device, in response to detection of audible speech inputs indicative of a user input. The speech processing device interprets the speech input data to identify one or more inputs corresponding to user inputs. Input data is generated indicative of the inputs, with this being provided to the interaction processing system, enabling the interaction processing system to use the input data to identify content interaction and then perform the content interaction.

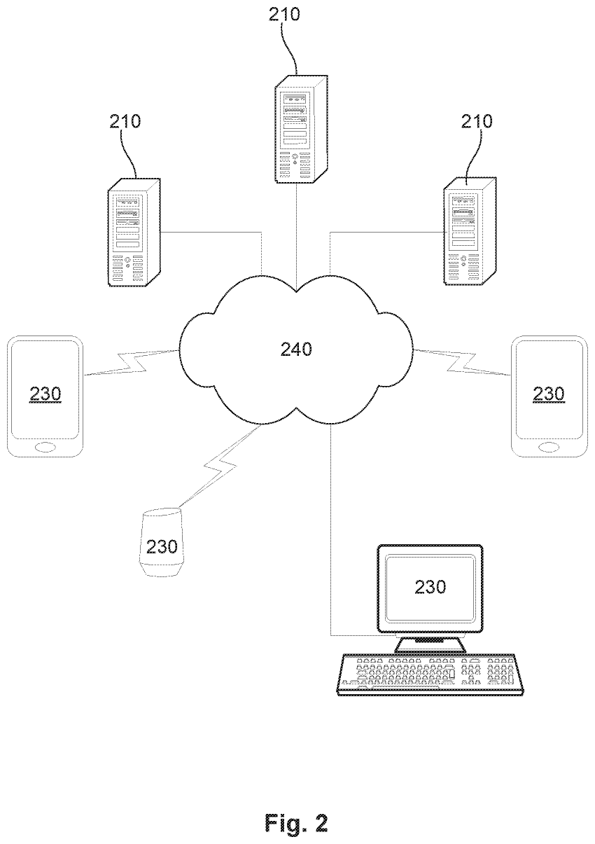

In one example, the process is performed by one or more computer systems operating as part of a distributed architecture, an example of which will now be described with reference to FIG. 2.

In this example, a number of processing systems 210 are provided coupled to one or more client devices 230, via one or more communications networks 240, such as the Internet, and/or a number of local area networks (LANs).

Any number of processing systems 210 and client devices 230 could be provided, and the current representation is for the purpose of illustration only. The configuration of the networks 240 is also for the purpose of example only, and in practice the processing systems 210 and client devices 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In this example, the processing systems 210 are adapted to provide access to content and/or to interpret speech input provided via a speech enabled client device 230. Whilst the processing systems 210 are shown as single entities, it will be appreciated they could include a number of processing systems distributed over a number of geographically separate locations, for example as part of a cloud-based environment. Thus, the above described arrangements are not essential and other suitable configurations could be used.

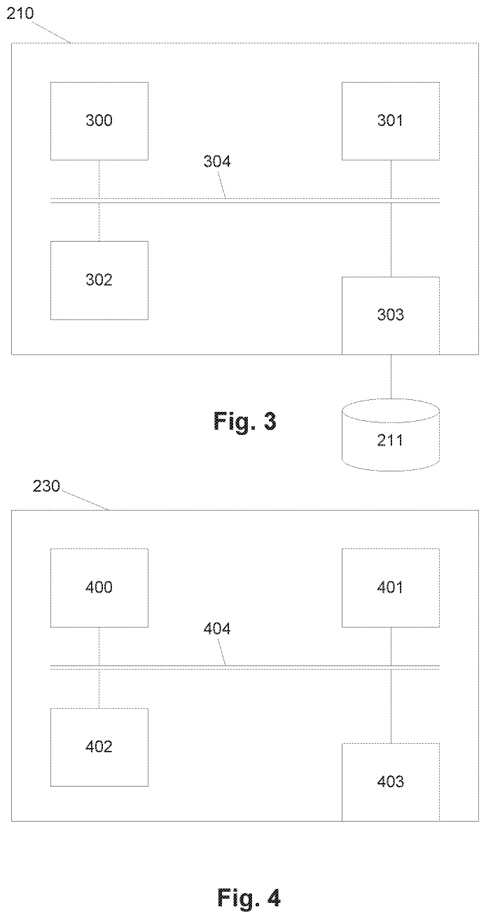

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 240, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing systems 210 may be formed from any suitable processing system, such as a suitably programmed PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, a client device 230 includes at least one microprocessor 400 a memory 401, an input % output device 402, such as a keyboard and/or display and an external interface 403, interconnected via a bus 404 as shown. In this example the external interface 403 can be utilised for connecting the client device 230 to peripheral devices, such as the communications networks 240, databases, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401, to allow relevant processes to be performed, including allowing communication with one of the processing systems 210, and/or to generate audible speech output or detect audible speech input, in the case of a speech enabled client device.

Accordingly, it will be appreciated that the client device 230 be formed from any suitably programmed processing system and could include suitably programmed PCs. Internet terminal, lap-top, or hand-held PC, a tablet, a smart phone, or the like. However, it will also be understood that the client device 230 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for presenting and interacting with content, including providing access to secure services, will now be described in further detail. For the purpose of these examples it is assumed that one or more respective processing systems 210 are servers (and will hereinafter be referred to as servers), and that the servers 210 typically execute processing device software, allowing relevant actions to be performed, with actions performed by the server 210 being performed by the processor 300 in accordance with instructions stored as applications software in the memory 301 and/or input inputs received from a user via the I/O device 302. It will also be assumed that actions performed by the client devices 230, are performed by the processor 400 in accordance with instructions stored as applications software in the memory 401 and/or input inputs received from a user via the I/O device 402.

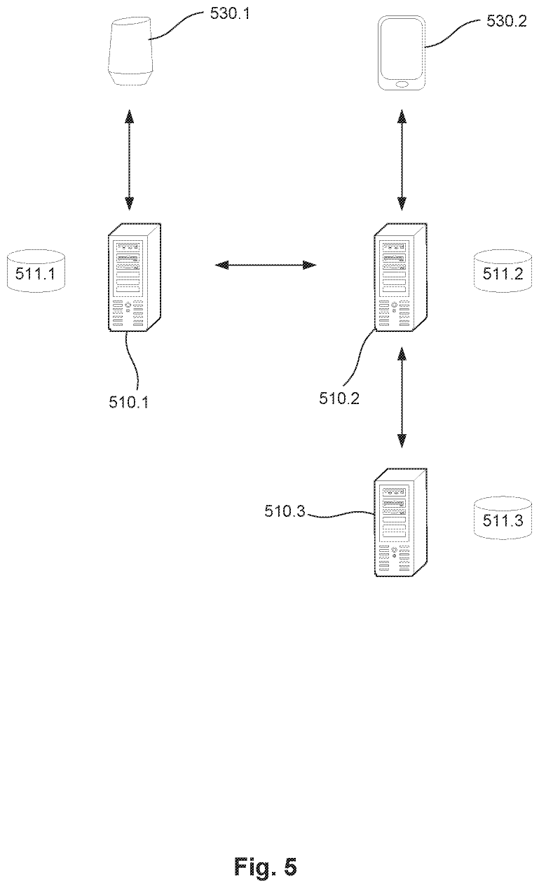

Typically, different types of server are provided to provide the required functionality, and an example of a functional arrangement of the above described system will now be described with reference to FIG. 5.

In this example, the system includes a user interface system 500, including a speech enabled client device 530.1, which interacts with a speech server 510.1, allowing the speech server 510.1 to interpret spoken inputs provided by a user and allowing the speech server 510.1 to generate speech data, which can then be used by the speech enabled client device 530.1 to generate audible speech output. The user interface system 500 also typically includes a speech database 511.1, which is used to store interface system user accounts, access tokens, and other information required to perform the necessary speech processing.

In this example, an interaction server 510.2 is provided, which is able to communicate with the speech server 510.1, to receive input data indicative of user input inputs and to allow generated interface data to be provided, to enable the user interface system 500 to present a user interface. The interaction server 510.2 is connected to an interaction database 511.2, which stores details of interaction system user accounts and interface code, used to interpret content code, and generate interfaces.

The interaction server 510.2 is also in communication with a second user client device 530.2, which allows the user to interact directly with the interaction processing system 510.2 via an app or other suitable mechanism, and a content server 510.3, such as a web server, to allow content code to be retrieved from a content database 511.3, and provided to the interaction server 510.2 as needed.

However, it will be appreciated that the above described configuration assumed for the purpose of the following examples is not essential, and numerous other configurations may be used. It will also be appreciated that the partitioning of functionality between the different processing systems may vary, depending on the particular implementation.

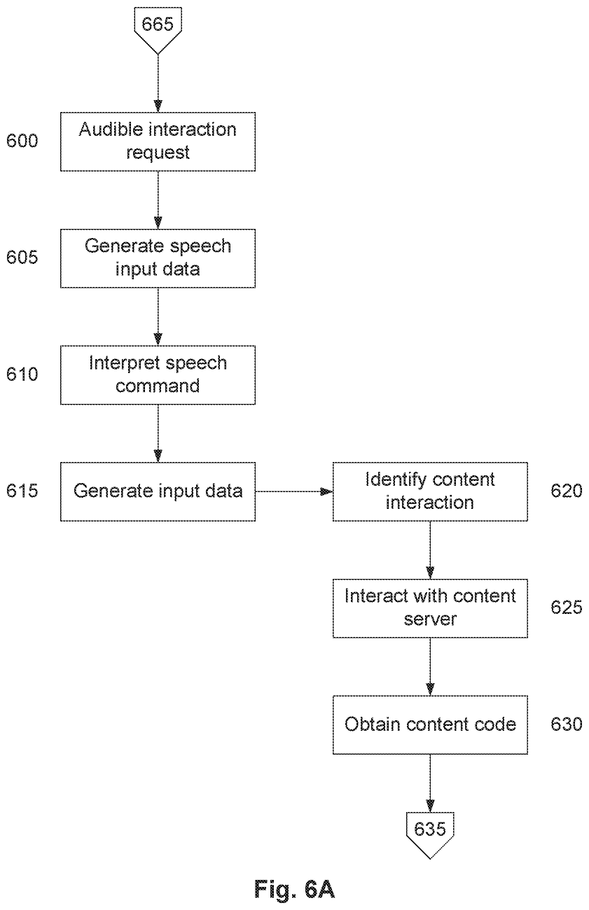

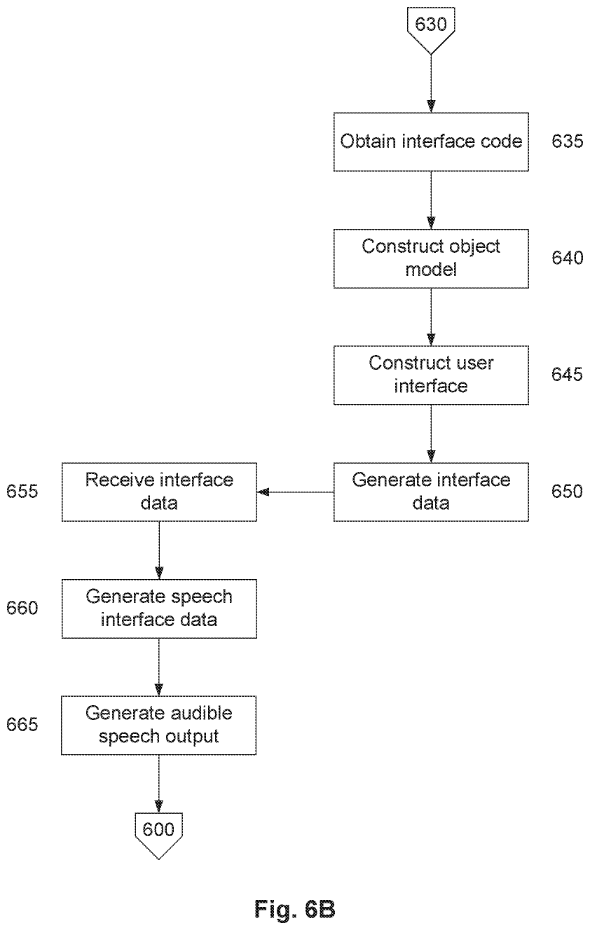

An example of an audible interaction process will now be described with reference to FIGS. 6A and 6B.

In this example, at step 600, a user provides an audible speech input, typically in the form of interaction request, which is achieved by speaking to the speech enabled client device 530.1. The interaction request could specify a service to be accessed, or including details of a URL or other address, to allow relevant content associated with the interaction to be retrieved. The speech enabled client device 530.1 generates speech input data at step 605, which is then uploaded to the speech sever 510.1, allowing the speech server 510.1 to interpret the speech input data and identify the speech input at step 610.

In particular, the speech server 510.1 will typically execute a local software application, provided by the interaction server 510.2, which provides instructions to the speech server 510.1 regarding how speech input relevant to the interaction server 510.2 should be interpreted. For example, the user might speak a input of the form “<Trigger phrase>, tell the interaction server to access my bank account”. The trigger phrase is used to instruct the speech server 510.1 to interpret the following speech as a input. The “tell the interaction server” statement, instructs the speech server 510.1 to launch an application provided by the interaction server 510.2 to assist with interpreting any spoken inputs. The “to access my bank account” is interpreted as a input to be provided to the interaction server 510.2.

Accordingly, at step 615, the speech server 510.1 generates input data indicative of the speech input, in this case “access my bank account”, transferring this to the interaction server 510.2, allowing the interaction server 510.2 to identify content interaction that is required at step 620.

It will be appreciated that the above described steps are largely standard steps associated with the operation of virtual assistants, and this will not therefore be described in any further detail.

The content interaction can be of any appropriate form, and could include entering text or other information, selecting content, selecting active elements, such as input buttons, or hyperlinks, or the like. Typically as part of this process, the interaction server 510.2 uploads information to the content server 510.3 at step 625, allowing the content server 510.3 to take any necessary action and then provide content code at step 630. For example, if the input includes a webpage URL, or selection of a hyperlink, the content server 510.3, would use this to retrieve the relevant content code. However, alternatively, if the interaction includes form completion, the content server 510.3 might need to update a webpage to represent entered information, providing content code indicative of the updated webpage.

In one example, the action needed might be wholly specified by the input. However, in other examples, interpretation may be required. So, in the current example of providing access to a user's bank account, the interaction server 510.2 might need to access a interaction system user account and identify the relevant banking webpage associated with the user's bank account, before requesting the banking portal website code from the relevant banking web server. Once a request has been made, the content server 510.3 typically returns content code such as HTML code, to the speech server 510.2.

Simultaneously with this, at step 635, interface code is obtained by the interaction server 510.2, typically by retrieving this from the interaction database 511.2, using the content address. The interface code and content code can then be used to construct a user interface, typically by populating an interface structure with content obtained from the content code.

In particular, at step 640, the interaction server 510.2 uses an internal browser application to construct an object model indicative of the content, from the content code. The object model typically includes a number of objects, each having associated object content, with the object model being usable to allow the content to be displayed by the browser application. In normal circumstances, the object model is used by a browser application in order to construct and subsequently render the webpage as part of a graphical user interface (GUI), although this step is not required in the current method. From this, it will be appreciated that the object model could include a DOM (Document Object Model), which is typically created by parsing the received content code.

Following this, the interaction server 510.2, extracts any required object content needed to present the interface using the object. In this regard, the required object content is typically specified by the interface code, so that the speech server 510.2 can use this information to extract the relevant object content from object model and use these to generate a user interface at step 645, typically by populating fields within the interface code with the object content.

In one example, the above processes are performed by having the interaction server 510.2 execute a browser application to retrieve the content and generate the object model, whilst an interface application is used to obtain the object code and populate an interface structure and thereby generate the interface. However, it will also be appreciated that this is not essential and alternative approaches could be used. The user interface is typically indicative of at least some of the object content and/or one or more available user inputs, thereby allowing content to be presented to the user and/or appropriate user inputs to be provided by the user. The user interface is typically simplistically designed and generally includes a single question or piece of information which is then presented together with one or more available response options, to thereby simplify the process of interacting with the content. In particular, this allows the user to interact with the content entirely non-visually.

At step 650, the interaction server 510.2 uses the user interface to generate interface data, which is uploaded to the speech server 510.1 at step 655. In this regard, the interface data typically specifies the content of the user interface to be presented, and may include additional presentation information specifying how the content should be presented, for example to include details of emphasis, required pauses, or the like. In one example, this can be achieved using style sheets associated with the content data.

This allows the speech server 510.1 to generate speech interface data at step 660, which is then uploaded to the speech enabled client device 530.1, allowing this to generate audible speech output at step 665. Again, this is performed in accordance with normal processes of the user interface system 500, and this will not therefore be described in any further detail.

The process can then return to step 600, allowing the user to provide an audible response, with this process being repeated as required. For example, the user input could specify the selection of a presented user interface option, which may in turn cause further content to be retrieved and presented. Additionally, and/or alternatively, other interactions could be performed, such as entering text or other information. In general, even for responses of this form, similar steps might be required, for example, uploading entered information to the content server 510.3, allowing the webpage to be updated, and any associated actions taken.

Accordingly, it will be appreciated that the above described process allows speech interaction with a website to be performed. To operate effectively, the simplified interface typically displays a limited amount content corresponding to a subset of the total content and/or potential interactions that can be performed based on the content code. This allows this the interface to be vastly simplified, making this easier to navigate and interact with the content in a manner which can be readily understood. This approach also allows multiple interfaces to be presented in a sequence which represents a typical task workflow with the webpage, allowing a user to more rapidly achieve a desired outcome, whilst avoiding the need for the user to be presented with superfluous information.

The interface is presented using separate interface code, additional to the content code, meaning that the original content code can remain unchanged. Furthermore, all interaction with the content server is achieved using standard techniques and in one example, can be performed using a browser application, meaning from the perspective of the content server there is no change in the process of serving content. This means the system can be easily deployed without requiring changes to existing content code or website processes.

Furthermore, the interface also operates to receive user speech inputs, interpret these and generate control instructions to control content interactions. Thus, it will be appreciated that the interface acts as both an input and output for content interactions, so that the user need only interact with the user interface system. As the interfaces can be presented in a strictly controlled manner, this provides a familiar environment for users, making it easier for users to navigate and digest content, whilst allowing content from a wide range of disparate sources to be presented in a consistent manner.

A number of further features associated with the above described process will now be described.

In one example, the user interface typically includes a plurality of interface pages wherein the method includes presenting a number of interface pages in a sequence in order to allow tasks to be performed. Thus, interface pages can be utilised in order to ascertain what task the user wishes to perform and then break down that task into a sequence of more easily performed interactions, thereby simplifying the process of completing the task.

The process of presenting the sequence of interface pages is typically achieved by presenting an interface page, determining at least one user input in response to the presented interface page, selecting a next interface page at least partially in accordance with the user input and then presenting the next page, allowing this process to be repeated as needed until desired interactions have been performed. The sequence of interface pages is typically defined in the interface code, for example by specifying which interface page should be presented based on the previous displayed page and a selected response. In this manner, a workflow to implement tasks can be embodied within the interface code, meaning it is not necessary for the user to have any prior knowledge of the website structure in order to perform tasks.

Whilst the interface pages can be defined wholly within the interface code, typically at least some of the interface pages will present a portion of the content, such as a particular part of the website. In order to ensure that the correct content is retrieved and displayed, the required content is specified within the interface code. As content can be dynamic or change over time, the content is typically defined in a manner which allows this to be reliably retrieved, in particular by specifying the object from which content should be obtained. Accordingly, when an interface page is to be displayed, the method typically includes having the interface application determine required object content for the next interface page in accordance with the interface code, obtain the required object content and then generate the next user interface page using the required object content.

In one particular example, the process of retrieving content typically involves having the interface application determine required object content using the interface code, generate an object request indicative of the required object content and provide the object request to the browser application. In this instance, a browser application receives the object request, determines the required object content, typically from the constructed object model, generating an object content response indicative of the required object content and then providing the object content response to the interface application.

It will be appreciated that as part of this process, if expected content isn't available, then alternative object content could be displayed, as defined in the interface code. For example, if a request resource isn't available, an alternative resource and/or an error message could be presented, allowing exception handling to be performed.

In order to allow the interface pages to be generated in a simple manner, whilst incorporating object content, the interface code typically defines a template for at least one interface page, with the method including generating the next user interface page by populating the template using the required object content. This allows the required object content to be presented in a particular manner thereby simplifying the meaning. This could include for example breaking the object content down into separate items which are then presented audibly in a particular sequence or laid out in a particular manner on a simplified visual interface.

In one particular example, the object content can include a number of content items, such as icons or the like, which may be difficult for a visually impaired user to understand. In order to address this, the interface application can be adapted to identify one or more interface items corresponding to at least one content item using the interface code and then generate the next interface page using the interface item. Thus, content items that are difficult to present audibly can be substituted for more understandable content, referred to as interface items. For example, an icon showing a picture of a train could be replaced by the word train which can then be presented in audible form.

In one example, as content pages may take time to generate, for example if additional content has been requested from a content server, an audible cue can be presented while the interface page is created, thereby alerting the user to the fact that this is occurring. This ensures the user knows the interface application is working correctly and allows the user to know when to expect the next interface page to be presented.

The interface pages can be arranged hierarchically in accordance with a structure of the content. For example, this allows interface pages to be arranged so that each interface page is indicative of a particular part of a task, such as a respective interaction and one or more associated user input options, with the pages being presented in a sequence in accordance with a sequence of typical user interactions required to perform a task. This can include presenting one or more initial pages to allow the user to select which of a number of tasks should be performed, then presenting separate pages to complete the task. It will be appreciated that this assists in making the content easier to navigate.

In one example, the process of presenting interface pages involves determining the selection of one of a number of interaction response options in accordance with user input inputs and then using the selected interaction response option to select a next interface page or determine the browser instruction to be generated.

Thus, it will be appreciated from the above that the interface code controls the manner and order in which interface pages are presented and the associated actions that are to be performed. The interface code also specifies how the browser is controlled, which can be achieved by having the interface code define the browser instructions to be generated, in one example, defining a respective browser instruction for each of a number of response options. This could be achieved by having the interface code include a script for generating the browser instructions, or could include scripts defining the browser instructions, which form part of the interface code and can simply be transferred to the browser as required. Thus all browser instructions required to interact with the content are defined within the interface code, meaning the interface application is able to generate an appropriate instruction for any required interaction.

Further details of the above described content presentation process are described in copending application WO2018/132863, the contents of which is incorporated herein by cross reference.

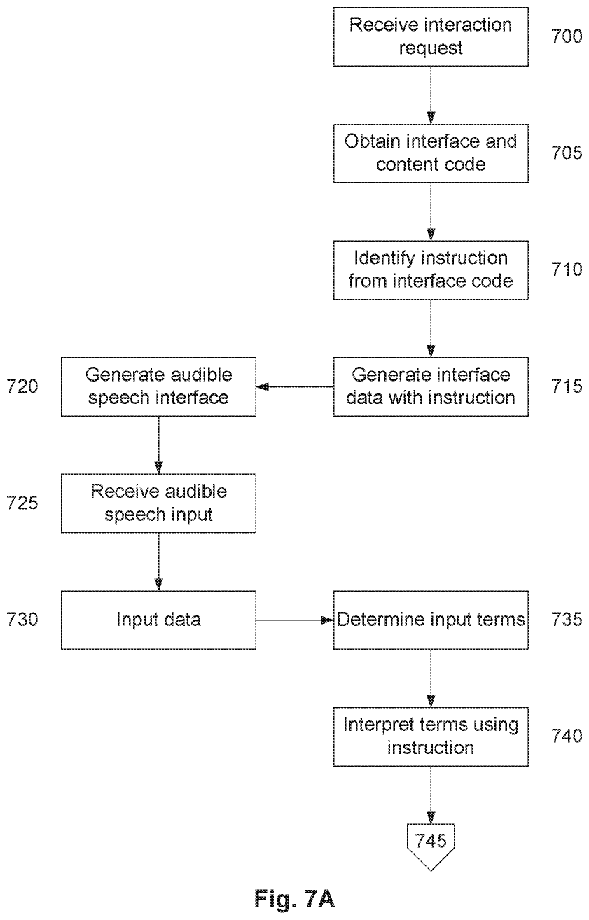

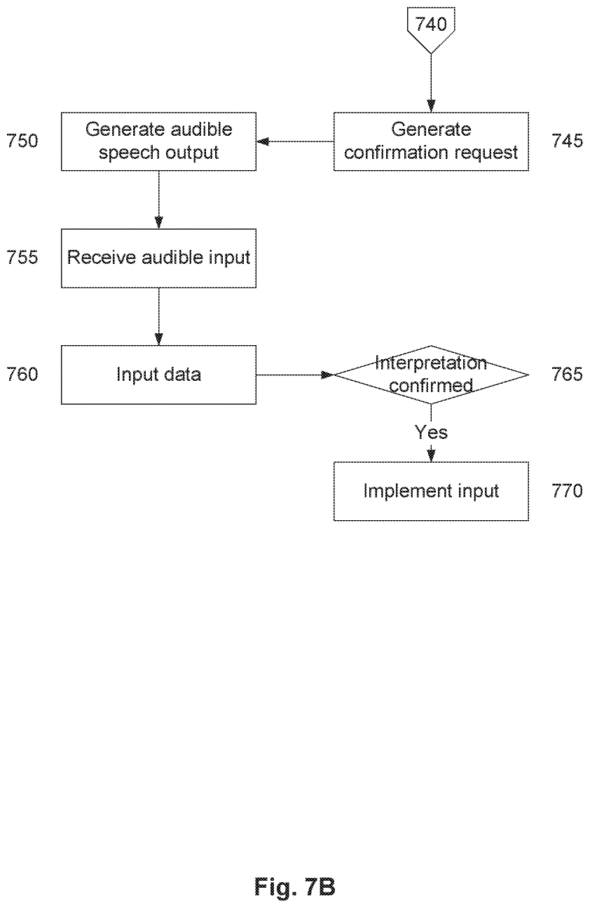

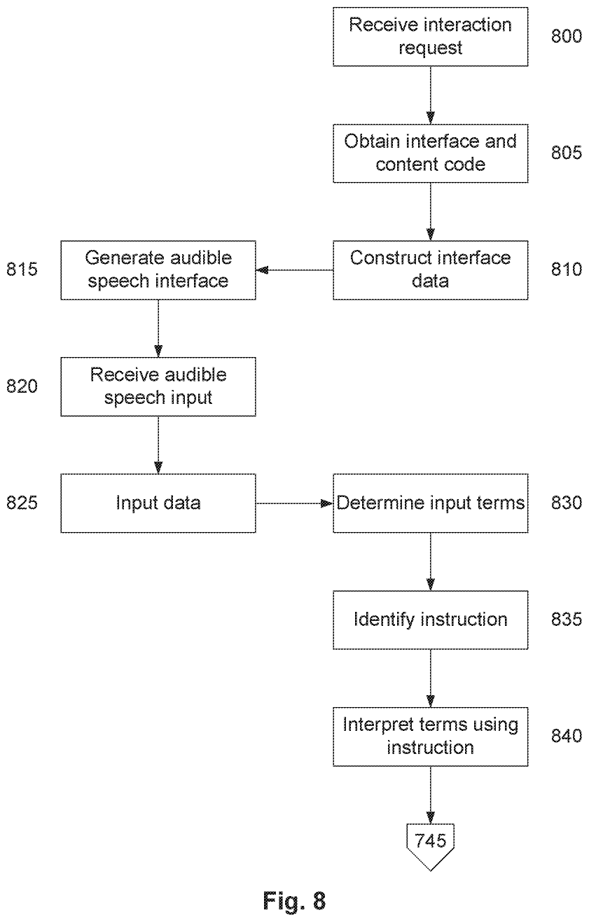

A further example process for interpreting speech input will now be described with reference to FIG. 7A and FIG. 7B.

In this example, the interaction server 510.2, receives an interaction request from the speech server 510.1 at step 700, using this to obtain interface and content code at step 705. This is performed in a manner similar to that described above, and typically involves retrieving interface code from the interaction database 511.2, and the content code from the content server 510.3.

At step 710, the interaction server 510.2 identifies an instruction within the interface code, and uses this to generate the interface data at step 715, so that the interface embodies the instruction and in particular, informs the user how to verbalise a user input.

The interface data is then transferred to the speech server 510.1, which generates speech interface data, which is provided to the speech enabled client device 530.1, allowing the speech enabled client device 530.1 to output the interface as audible speech, including the instruction, at step 720.

At step 725, the user responds providing the audible speech input, which is converted into speech input data by the speech enabled client device 530.1 and transferred to the speech server 510.1, to allow this to be analysed at step 725. The speech input data is analysed to identify one or more terms, which are then used to construct input data at step 730, with this being returned to the interaction server 510.2, allowing the interaction server to determine the input terms at step 735. The input terms are then interpreted using the instruction at step 740, for example by using spelt letters in order to reconstruct an entire word, as described above.

At step 745, a confirmation request is generated by the interaction server 510.2, with this being transferred to the speech server 510.1 to allow the speech server 510.1 to generate audible speech output data, which is then presented as audible output by the speech enabled client device 530.1 at step 750. The speech enabled client device 530.1 will spell out the user input allowing the user to confirm if this is correct by providing an appropriate response at step 755.

The audible input response is provided in the form of speech input data to the speech server 510.1 which converts this to input data at step 760 transferring this to the interaction server 510.2 allowing the interaction server to confirm the interpretation is correct at step 765. Assuming this to be the case the input can be implemented at step 770. Otherwise, corrective action can be taken, such as returning to step 720 to request the user provide the input again.

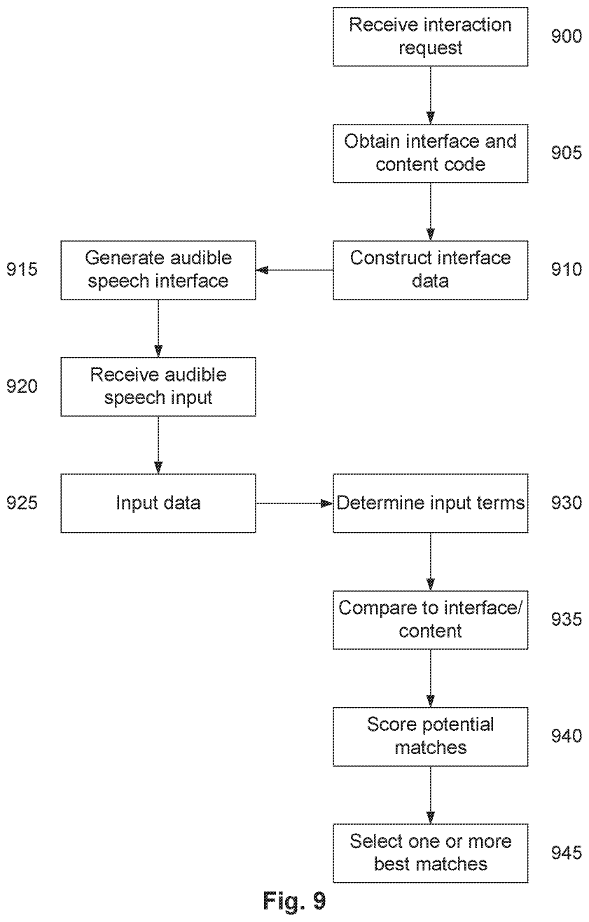

A further example process will now be described above with respect to FIG. 8.

In this example, at steps 800 and 805 an interaction request is received by the interaction server 510.2 and used to obtain interface and content code at step 805. At step 810 the interaction server 510.2 generate interface data which is transferred to the speech server 510.1, which converts this to an audible speech interface for output by the speech enabled client device 530.1 at step 815. At step 820 audible speech input is provided via the speech enabled client device 530.1, with this being transferred as speech input data to the speech server 510.1, allowing this to generate input data by performing speech recognition at step 825. The resulting input data is transferred to the interaction server 510.2, at step 830, allowing this to determine input terms.

At step 835 the interaction server 510.2 identifies an instruction from the provided speech input and uses this to interpret the terms at step 840. The process can then proceed to step 745 allowing the interpreted terms to be confirmed as previously described. Thus, it will be appreciated that this example is generally similar to the example of FIGS. 7A and 7B, but with the instruction being determined from user input as opposed to the interface.

A further example process for interpreting speech input will now be described with reference to FIG. 9.

In this example, an interaction request is received by the interaction server 510.2 at step 900, and used to obtain interface and content code at step 905, substantially as described above. At step 910 an interface is constructed and used to generate interface data with this being transferred to the speech server 510.1, which in turn generates an audible speech interface, with this being output via the speech enabled client device 530.1, at step 915.

Audible speech input is received at step 920 with the speech enabled client device 530.1 converting this to speech input data which is provided to the speech server 510.1 allowing the speech server 510.1 to determine input data at step 925. The input data is returned to the interaction server 510.2 which determines input terms at step 930. It will be appreciated that these steps are broadly similar to steps 800 to 830 as described above.

At step 935 the interaction server 510.2 compares the input terms to the interface and/or content in order to score, potential interpretations for the input terms at step 940.

For example, a word or phrase matching process is performed, using distance matching algorithms and/or fuzzy logic in order to evaluate, For example, this might take input terms, and then identify multiple terms have a similar pronunciation or sounding. These terms are then compared to the interface or content, in order to score the likelihood of each of the different terms being correct.

In one example, this could be achieved using context associated with the content. For example, the terms “wear”, “where” and “ware”, all sound identical. However, if the interface or content refers to clothing, the correct interpretation is likely to be “wear”, whilst if it relates to a location, the term “where” is more likely.

Finally, another option is to compare the input terms to a user profile, which can include stored data indicative of terms commonly used by a particular user, and/or user information. For example, if the input is a name, such as John, a comparison to a user profile can be used in order to resolve ambiguities in spelling between Jon and John. In this instance, user identification may need to be performed, in which case this can be achieved by the speech server 510.1, based either on voice recognition and/or a particular speech enabled client device 530.1 being used. In this situation, the identity of the user is used to retrieve a user account associated with the interaction system, in turn allow stored data such as a profile to be retrieved and used to resolve ambiguity.

Once or more best matches are selected, then at step 945 the process can return to step 745 to allow one or more potential matches to be presented to the user and a match confirmed.

Accordingly, it will be appreciated that the above described process operates by analysing terms derived from speech input, and using the analysis to resolve ambiguities that arise as a result of the speech recognition process. Analysis can be performed by way of word matching, spelling reconstruction and/or comparison to existing stored data associated with a user. This allows accurate data entry to be achieved for speech based systems, without requiring the system to be trained based on the user's particular voice.

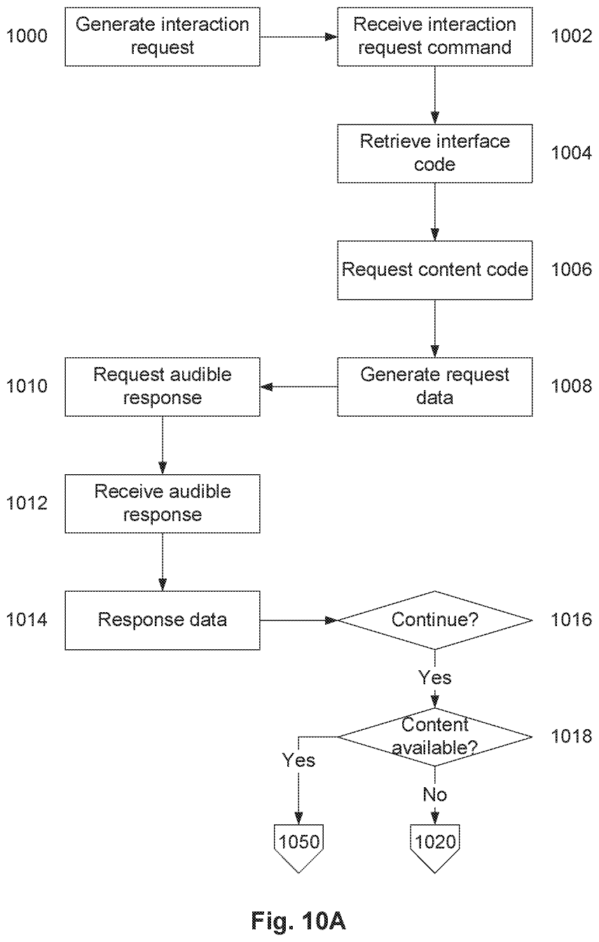

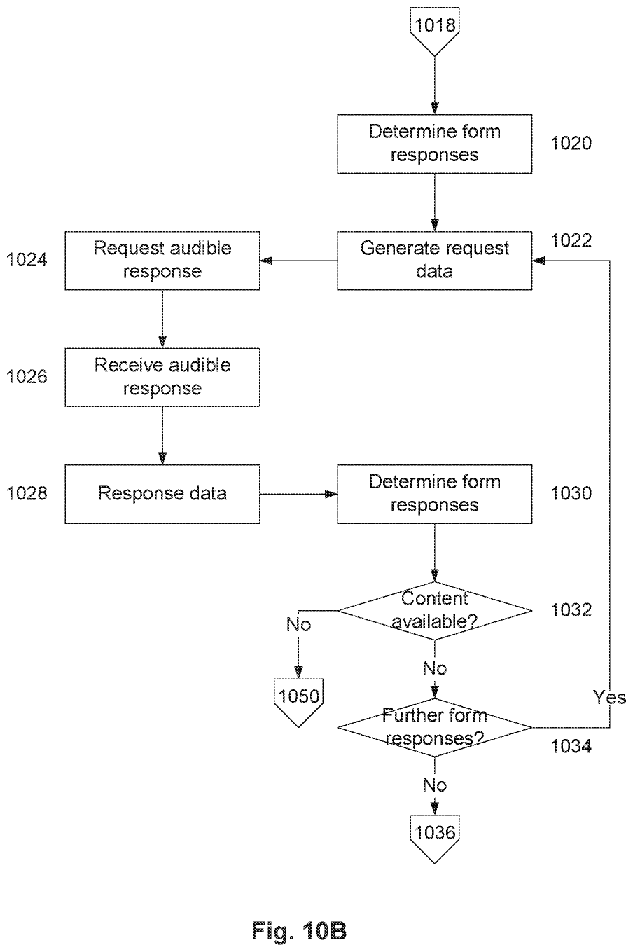

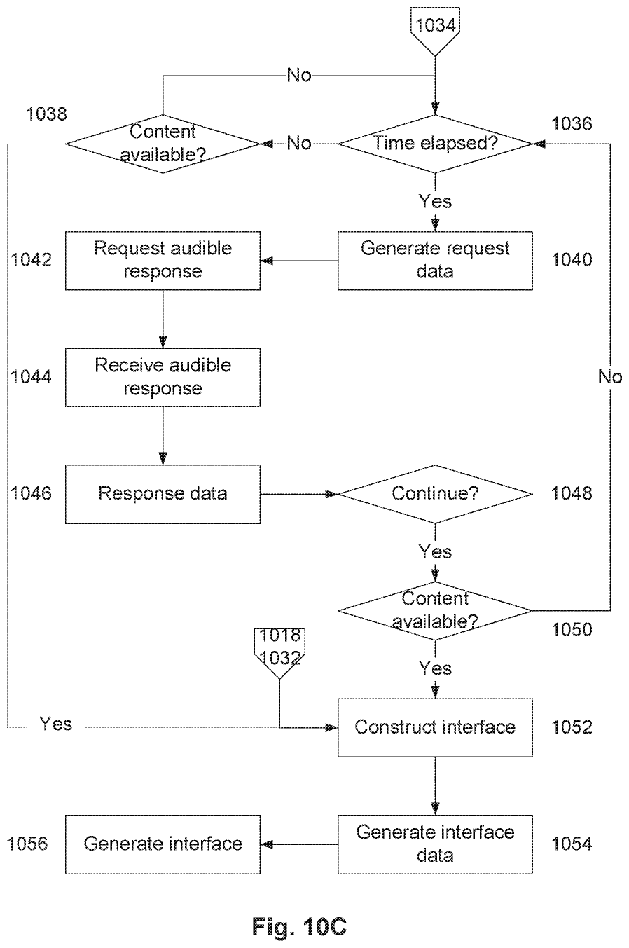

An example of a process for performing an interaction including using response requests will now be described with reference to FIGS. 10A to 10C.

For the purpose of this example, requesting of audible responses from a user is performed in a hierarchical fashion, first seeking confirmation that the interaction request is correct, then seeking responses to complete a form where appropriate and finally providing further audible response requests in the event that a further delay is required to avoid a timeout. It will be appreciated that in practice any one or more of these mechanisms could be used and that the example of performing these in the manner described is for the purpose of illustration only. Furthermore, whilst reference is made to form completion, it will be appreciated that similar techniques could be applicable to any input the user may be required to make in a subsequent part of the interaction, and that reference to forms is for the purpose of illustration only.

In this instance, at step 1000, an interaction request is generated, for example by having the user provide spoken inputs via the speech enabled client device 530.1, with these then being interpreted by the speech server 510.1, allowing interaction request commend data to be generated. The interaction request input data is transferred to the interaction server 510.2 at step 1002, with the interaction server 510.2 using the interaction request to identify the interaction to be performed, and in one example, to identify a content address of content code to be retrieved. It will be appreciated that the content address could form part of the interaction, request, or could be derived therefrom, for example based on a user selection of a response option associated with a previously displayed interface. The content address is used to retrieve interface code from the interaction database 511.2 at step 1004 and request content code from the content server 510.3 at step 1006.

As steps 1004 and 1006 are performed, at step 1008 the interaction server 510.2 also generates request data, which is indicative of the interaction request made by the user and which is transferred to the speech server 510.1, causing the speech server to request an audible response from the user at step 1010. In particular, this is achieved by having the speech server 510.1 generate speech interface data, which is provided to the speech enabled client device 530.1, causing an audible request to be made. In this example, the audible request restates the interaction request made by the user, and requests that the user confirm that the interaction specified is correct. For example, this could state “You asked us to retrieve website <website name>, is this correct?”.

At step 1012, the user provides an audible response, which is converted to speech input data by the speech enabled client device 530.1, and returned to the speech server 510.1, allowing this to be interpreted by the speech server 510.1 and used to generate response data at step 1014. Thus, the speech server 510.1 will receive speech input data, which is indicative of audio data captured by the speech enabled client device 530.1, and convert this to words, which are then transferred to the interaction server 510.2. The interaction server 510.2 uses the user response to determine if the interaction process should continue at step 1016, and if not, further action can be halted.

Otherwise, assuming that the process is to continue, the interaction server 510.2 determines if the content requested from the content server 510.3 is yet available, or is predicted to be available, and if not, the process moves on to step 1020.

At step 1020, the interaction server 510.2 parses the retrieved interface data and uses this to determine any form, or other, responses that are to be required in the content interaction. For example, the interaction may correspond to completing a form, in which case the interaction server 510.2 can identify form fields from the interface data, and hence identify response that will be required. It will be appreciated that as the interface data is typically stored locally, this process can commence before the content code has actually been retrieved.

At step 1022, the interaction server 510.2 generates request data requesting one or more responses from the user, with the requested responses relating to the form fields that will need to be completed. The request data is transferred to the speech server 510.1, which in turn requests audible responses from the user via the speech enabled client device 530.1, at step 1024. Thus, for example, this could ask the user to confirm their travel destination and departure time, or the like.

Audible responses are received via the speech enabled client device 530.1 and returned to the speech server 510.1, which provides response data to the interaction server 510.2. It will be appreciated that steps 1022 to 1028 are largely analogous to steps 1008 to 1014, and these will not therefore be described in any further detail.

The response data is analysed by the interaction server 510.2, at step 1030, which determines the user responses and stores these, allowing them to be used in subsequent form population.

At step 1032, the interaction server 510.2 determines if the content is available, and if not, determines if there are any further form responses to be requested at step 1034. If so, the process returns to step 1022, allowing steps 1022 to 1034 to be repeated either until the content is ready, or all form responses have been obtained.

In the event that all form responses have been completed, and the content has not yet been received, the interaction server 510.2 can determine if a time limit, typically slightly shorter than the timeout period, has elapsed at step 1036, and if not, continue to wait and check if the content is available at step 1038. However, if the limit has elapsed, for example, if three or four seconds have passed since the previous response and a timeout is imminent, the process continues to step 1040, with the interaction server 510.2 generating request data indicative of a standard phrase, such as an indication that the content is being retrieved and asking if the user is happy to wait. The response data is transferred to the speech server 510.1, allowing an audible response to be requested at step 1042, a response received at step 1044 and response data generated at step 1046. This is again performed in a manner similar to that described above with respect to steps 1024 to 1028 and will not be described in further detail.

Once response data has been received by the interaction server 510.2, the interaction server 510.2 can assess if the process should continue at step 1048 and if so whether content is yet available at step 1050. If not, the process returns to step 1036, with the process being repeated until such time as the content is received or the user fails to respond or declines to continue waiting.

Once the content is received, the interface can be constructed at step 1052 in a manner similar to that described above, with this being used to generate interface data at step 1052, which can be transferred to the speech server, allowing a speech enabled interface to be generated at step 1054.

Accordingly, it will be appreciated that the above described arrangement provides a mechanism to generated repeated response requests, which can be used to prevent the user interface system timing out, whilst also helping to maintain the conversational nature of the user interaction with the system. Furthermore, in one example, the manner in which this is performed helps collect information that will be used in downstream processes, thereby avoid unnecessary delays in collecting information needed to perform interactions.

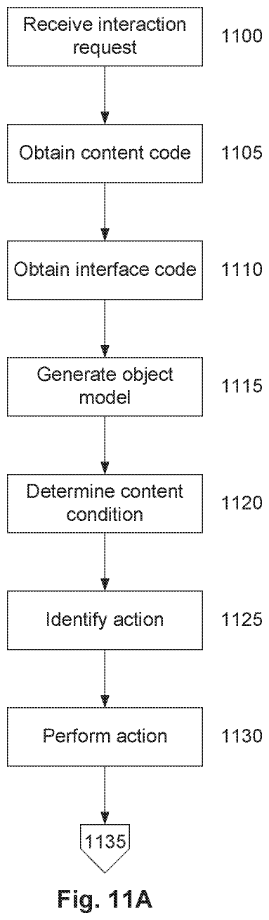

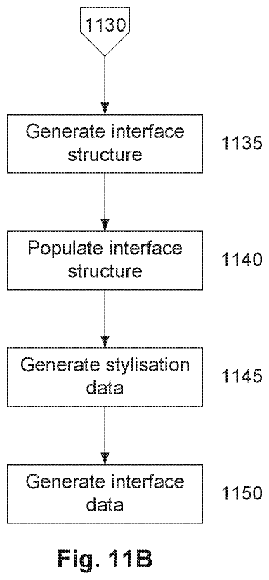

A further example of a process for presenting content will now be described with reference FIGS. 11A and 11B.

In this particular example, at step 1100 the interaction server 510.2 receives an interaction request from a speech server 510.1. This is typically performed in a manner similar to that described above and involves the speech server 510.1 interpreting speech data received from a speech enabled client device 530.1 and using this to generate an interaction request.

At step 1105 the interaction server 510.2 retrieves content code, typically by requesting this from a content server 510.3, before retrieving interface code from the interaction database 511.2, at step 1110.

At step 1115 the interaction server 510.2 generates an object model, for example by processing the content code utilising a browser application, or similar. Having constructed the object model, at step 1120, the interaction server 510.2 parses the content code and uses the results to determine a content state, for at least part of the content. This can be performed in a number of different manners, depending on the preferred implementation, and the nature of the content condition being identified, and a number of examples have been described above.

At step 1125, an action associated with the content condition is identified, with this being used to perform the action. The action is typically accessible based on the content condition, and could be defined as part of the interface code, or could be stored as part of action data in the interaction system database 511.2.

Thus, in one example, the action could include retrieving and executing executable code. In this example, JavaScript code is retrieved, which is specific to the respective content code and/or condition, with the JavaScript code being injected into the HTML code, with the interaction server 510.2 parsing the modified HTML file and constructing an updated DOM.

Alternatively, the interaction server 510.2 can retrieve processing rules from the interaction database 511.2, and use these to process the content, for example to omit or replace content. For example, this could involve parsing the HTML code and using a query language, such as XPath, to identify elements and attributes from the content code. An element type of each element can be identified, with this being used to remove or retain elements based on instructions defined in the processing rules.

Particular examples of actions include implementing a workflow navigation to transverse very complex form workflows, by omitting parts of the form that are hidden or disabled, based either on earlier user input or other completion of parts of the form. Another specific example action is to identify specific features, such as a URL, page element (XPath) state, or the like, and then use this information to redirect to a new point in the interface code, apply an overlay template in order to process the webpage, jump to a specific location on the webpage, or similar.

At step 1135, the interaction server 510.2 then uses the interface code to generate an interface structure, before populating this with object content obtained from the updated object model reflecting the processed content at step 1140.

At step 1145, style data, such as CSS documents, are retrieved and used to generate stylisation data. The stylisation data is used to control presentation of the interface allowing the interface data to be created at step 1150, with this then being provided to the speech server 510.1 allowing a speech interface to be generated and presented.

Accordingly, it will be appreciated that the above described process operates by processing content based on a content condition, using this to refine the content, allowing it to be presented to the user in a simplified manner, for example using a speech enabled system.

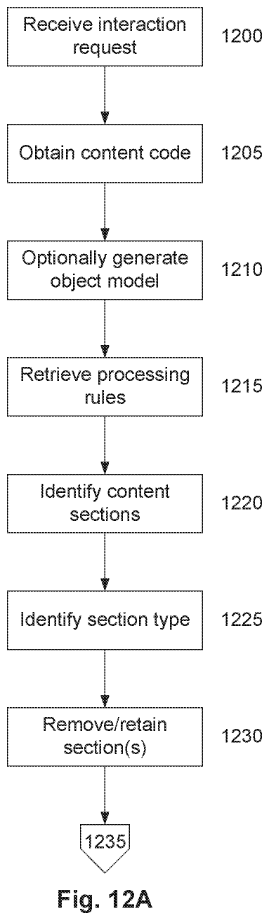

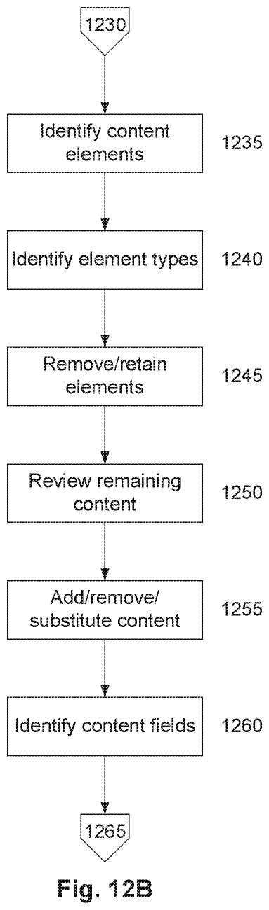

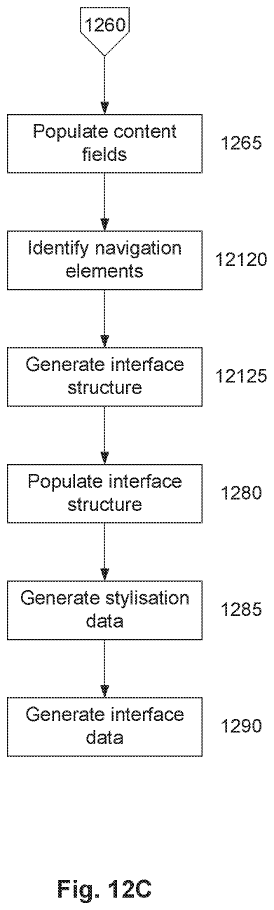

A further example of a process for presenting content will now be described with reference FIG. 12A to 12C.

In this particular example, at step 1200 the interaction server 510.2 receives an interaction request from a speech server 510.1. This is typically performed in a manner similar to that described above and involves the speech server 510.1 interpreting speech data received from a speech enabled client device 530.1 and using this to generate an interaction request.

At step 1205 the interaction server 510.2 retrieves content code, typically by requesting this from a content server 510.3. At step 1210 having received the content code, the interaction server 510.2 may optionally generate an object model, for example by processing the content code utilising a browser application, or similar. Simultaneously with this process, at step 1215 the interaction server 510.2 retrieves processing rules from the interaction database 511.2.

At step 1220 the interaction server 510.2 utilises the processing rules in order to process the content. In this example, this initially involves identifying content sections specified in the processing rules, for example examining the content code to determine if the content includes a header, footer, or other sections. At step 1225, a section type for each section is identified, typically in accordance with HTML tags associated with the section, with the relevant section being removed or retained at step 1230, based on instructions in the processing rules.

At step 1235, the interaction server 510.2 examines the remaining sections and identifies individual content elements within the remaining sections, again by parsing the HTML code and identifying elements using any query language, such as XPath, which can be used to identify elements and attributes from the content code. At step 1240, the content server 510.2 identifies an element type of each element and then removes or retains elements again based on instructions defined in the processing rules.

At step 1250 the interaction server 510.2 reviews the remaining content and then performs addition, removal or substitution of content at step 1255, based on instructions in the processing rules. The nature of the substitution will vary depending upon the preferred implementation, but could involve for example substituting graphical elements with associated text. Such substitutions could be achieved in a variety of manners, for example based on substitutions defined in the processing rules, by examining file names associated with images, or the like.

At step 1260, the interaction server 510.2 examines the content and identifies if the content contains content fields that can be automatically completed. If so, the content fields can be populated if defined user data is available. For example, user data may be previously generated and stored in the interaction database 511.2, allowing the interaction server 510.2 to retrieve the user data and identify whether any of the user data matches content field within the content.

At step 12120, the interaction server 510.2 identifies navigation elements associated with the remaining content. The navigation elements can be identified on many structures, the presence of interactive elements such as hyperlinks or similar or any other appropriate mechanism. The interaction server 510.2 then uses the navigation elements to generate an interface structure, before populating this with object content obtained from the object model at step 1280.

At step 1285, style data, such as CSS documents, are retrieved and used to generate stylisation data. The stylisation data is used to control presentation of the interface allowing the interface data to be created at step 1290, with this then being provided to the speech server 510.1 allowing a speech interface to be generated and presented.

Accordingly, it will be appreciated that the above described process operates by processing content using processing rules, using this to refine the content, allowing it to be presented to the user, for example using a speech enabled system. This allows content to be presented for which interface code is not defined, or is incomplete, enabling the system to be deployed with a wide variety of content.

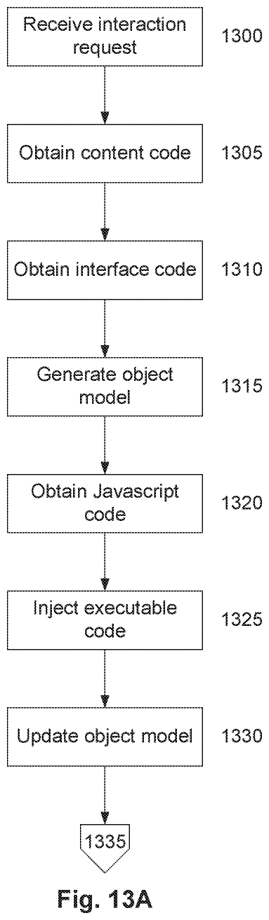

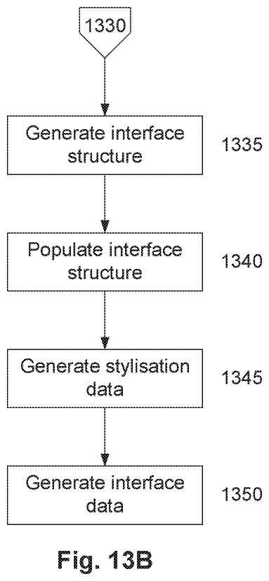

A further example of a process for presenting content will now be described with reference FIGS. 13A and 13B.

In this particular example, at step 1300 the interaction server 510.2 receives an interaction request from a speech server 510.1. This is typically performed in a manner similar to that described above and involves the speech server 510.1 interpreting speech data received from a speech enabled client device 530.1 and using this to generate an interaction request.

At step 1305 the interaction server 510.2 retrieves content code, typically by requesting this from a content server 510.3, before retrieving interface code from the interaction database 511.2, at step 1310.

At step 1315 the interaction server 510.2 generates an object model, for example by processing the content code utilising a browser application, or similar. Having constructed the object model, at step 1320, the interaction server 510.2 retrieves executable code, and in particular JavaScript code from the interaction database 511.2. This can be performed in a number of different manners, depending on the preferred implementation.

For example, the JavaScript code could be specific to the respective content code, in which case the JavaScript code could be retrieved based on a content address specified in the interaction request. Alternatively, the JavaScript code could be specific to the interface code, and could be called based on a function call in the interface code. In a further example, the JavaScript code is specific to particular content, or a particular type of content or content condition, in which case the interaction server 510.2, will typically parse the object model, and use results of this to retrieve the JavaScript code.

At step 1325, the interaction server 510.2 injects the JavaScript code into the content code, and updates the object model at step 1330. Specifically, injected JavaScript code is used to modify the HTML code, with the interaction server 510.2 parsing the modified HTML file and constructing an updated DOM.

```
  var priceSay = ‘’;
  if (pagePrice.includes(‘ − ’)) {
```

priceSay = ‘between ’ + pagePrice.replace(‘ − ’, ‘ and ’)

```
  + ‘ cents per litre’;
  } else if (pagePrice.includes(‘≥’)) {
```

priceSay = price.replace(‘≥’, ‘from’) + ‘ cents per

```
  litre’;
  } else {
```

priceSay = price. replace(‘≤’, ‘less than’) + ‘ cents per

```
  litre’;
  }
var fairness = pageFairness.length + ‘ out of 6 stars'
var sayString = pageStationName + ‘ has fuel prices ’ +
priceSay + ‘, with a fairness rating of ’ + fairness + ‘.’;
```

Accordingly, this acts to text on a webpage with a text string that is more easily understood in a spoken context.

At step 1335, the interaction server 510.2 then uses the interface code to generate an interface structure, before populating this with object content obtained from the updated object model reflecting the modified content at step 1340.

At step 1345, style data, such as CSS documents, are retrieved and used to generate stylisation data. The stylisation data is used to control presentation of the interface allowing the interface data to be created at step 1350, with this then being provided to the speech server 510.1 allowing a speech interface to be generated and presented.

Accordingly, it will be appreciated that the above described process operates by modifying content using executable code, using this to refine the content, allowing it to be presented to the user, for example using a speech enabled system.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) A system for enabling user interaction with content, the system including an interaction processing system, including one or more electronic processing devices configured to:
a) obtain content code representing content that can be displayed;
b) obtain interface code indicative of an interface structure;
c) construct a speech interface by populating the interface structure using content obtained from the content code;
d) generate interface data indicative of the speech interface; and,
e) provide the interface data to an interface system to cause the interface system to generate audible speech output indicative of a speech interface.

2) A system according to claim 1, wherein the system is for interpreting speech input and the interaction processing system is configured to:
a) receive input data from the interface system in response to an audible user inputs relating to a content interaction, the input data being at least partially indicative of one or more terms identified using speech recognition techniques;
b) perform analysis of the terms at least to determine an interpreted user input; and,
c) perform an interaction with the content in accordance with the interpreted user input.

3) A system according to claim 2, wherein the interaction processing system is configured to cause the interface system to obtain a user response confirming if the interpreted user input is correct.

4) A system according to claim 3, wherein the interaction processing system is configured to:
a) generate request data based on the interpreted user input;
b) provide the request data to the interface system to cause the interface system to generate audible speech output indicative of the interpreted user input;
c) receive input data from the interface system in response to an audible user response, the input data being at least partially indicative of the user response; and,
d) selectively perform the interaction in accordance with the user response.

5) A system according to claim 3, wherein the interaction processing system is configured to:
a) determine multiple possible interpreted user inputs; and,
b) cause the interface system to obtain a user response confirming which interpreted user input is correct.

6) A system according to claim 2, wherein the interaction processing system is configured to:
a) identify an instruction; and,
b) analyse the terms in accordance with the instruction to determine the interpreted user input.

7) A system according to claim 6, wherein the interaction processing system is configured to at least one of:
a) identify the instruction from at least one of:
i) the interface; and,
ii) using the terms; and
b) generate the interface data in accordance with the instruction.

8) (canceled)

9) A system according to claim 2, wherein the interaction processing system is configured to at least one of:
a) interpret at least some of the terms as letters spelling a word; and,
b) cause the interface system to:
i) generate audible speech output indicative of the spelling; and,
ii) obtain a user response confirming if the spelling is correct.

10) (canceled)

11) A system according to claim 2, wherein the terms include at least one of:
a) an identifier indicative of a previously stored user input;
b) natural language words; and,
c) phonemes.

12) A system according to claim 2, wherein the interaction processing system is configured to at least one of:
a) perform the analysis at least in part by:
i) comparing the terms to at least one of:
(1) stored data;
(2) the interface code;
(3) the content code;
(4) the content; and,
(5) the interface; and,
ii) using the results of the comparison to determine the interpreted user input; and,
b) compare terms using at least one of:
i) word matching;
ii) phrase matching;
iii) fuzzy logic; and,
iv) fuzzy matching.

13) (canceled)

14) A system according to claim 2, wherein the interaction processing system is configured to:
a) identify a number of potential interpreted user inputs;
b) calculate a score for each potential interpreted user input; and,
c) determine the interpreted user input by selecting one or more of the potential user inputs using the calculated scores.

15) A system according to claim 2, wherein the interaction processing system is configured to:
a) receive an indication of a user identity from the interface system; and,
b) perform analysis of the terms at least in part using stored data associated with the user using the user identity, wherein the stored data is associated with an interaction system user account linked to an interface system user account, and wherein the interface system determines the user identity using the interface system user account.

16) (canceled)

17) A according to claim 1, wherein the system is for facilitating speech driven user interaction with content and wherein the interaction processing system is configured to cause the user interface system to request an audible response from a user via the speech driven client device to thereby prevent session timeout whilst the interface data is generated.

18) A system according to claim 17, wherein the interaction processing system is configured to at least one of:
a) provide request data to the user interface system to cause the user interface system to request the audible response;
b) generate the request data based on the interaction request;
c) generate the request data based on the interface code;
d) retrieve predefined request data; and,
e) generate request data indicative of the interaction request and wherein the user interface system is responsive to the request data to request user confirmation the interaction request is correct via a speech driven client device.

19) (canceled)

20) (canceled)

21) A system according to claim 17, wherein the content includes a form, and wherein interaction processing system is configured to:
a) determine form responses required to complete the form using the interface code; and,
b) generate request data indicative of the form responses, wherein the user interface system is responsive to the request data to:
i) request user responses via a speech driven client device; and,
ii) generate response data indicative of user responses;
c) receive the response data;
d) use the response data to determine form responses; and,
e) populate the form with the form responses.

22) A system according to claim 17, wherein the interaction processing system is configured to:
a) determine a time to generate the interface data by at least one of:
i) monitoring the time taken to retrieve content data;
ii) monitoring the time taken to populate the interface structure;
iii) predicting the time taken to populate the interface structure; and,
iv) retrieving time data indicative of a previous time to generate the interface data:
and,
b) selectively generate response data depending on the time.

23) (canceled)

24) A system according to claim 1, wherein the interaction processing system is configured to at least one of:
a) receive an interaction request from an interface system and obtain the content code and interface code at least partially in accordance with the interaction request; and,
b) obtain the content code and the interface code in accordance with a content address.

25) (canceled)

26) A system according to claim 1, wherein the interface system includes a speech processing system that is configured to:
a) generate speech interface data;
b) provide the speech interface data to a speech enabled client device, wherein the speech enabled client device is responsive to the speech interface data to:
i) generate audible speech output indicative of a speech interface;
ii) detect audible speech inputs indicative of a user input; and,
iii) generate speech input data indicative of the speech inputs;
c) receive speech input data; and,
d) use the speech input data generate the input data.

27) A system according to claim 26, wherein the speech processing system is configured to at least one of:
a) perform speech recognition on the speech input data to identify terms, compare the identified terms of defined phrases and selectively generate the input data in accordance with results of the analysis; and,
b) receive the interface data and generate the speech interface data using the interface data.

28) (canceled)

29) A method for enabling user interaction with content, the method including, in an interaction processing system including one or more electronic processing devices:
a) obtaining content code representing content that can be displayed;
b) obtaining interface code indicative of an interface structure;
c) constructing a speech interface by populating the interface structure using content obtained from the content code;
d) generating interface data indicative of the speech interface; and,
e) providing the interface data to an interface system to cause the interface system to generate audible speech output indicative of a speech interface.

30) A computer program product for enabling user interaction with content, the system including an interaction processing system, including one or more electronic processing devices configured to:
a) obtain content code representing content that can be displayed;
b) obtain interface code indicative of an interface structure;
c) construct a speech interface by populating the interface structure using content obtained from the content code;
d) generate interface data indicative of the speech interface; and,
e) provide the interface data to an interface system to cause the interface system to generate audible speech output indicative of a speech interface.

31)-104) (canceled)
